(19) United States
(12) Patent Application Publication
(10) Pub. No.: US 2006/0271917 A1
(43) Pub. Date: Nov. 30, 2006

(54) State-based source code annotation

(75) Inventors: Manuvir Das, Sammamish, WA (US); Manuel Alfred Fahndrich, Seattle, WA (US); Ramanathan Venkatapathy, Redmond, WA (US); Yong Qu, Sammamish, WA (US); Donn Scott Terry, Woodinville, WA (US); Daniel Weise, Kirkland, WA (US); Brian Hackett, Ithaca, NY (US)

Correspondence Address: KLARQUIST SPARKMAN LLP, 121 S.W. SALMON STREET, SUITE 1600, PORTLAND, OR, 97204, US

(73) Assignee: Microsoft Corporation, Redmond, WA (US)

(21) Appl. No.: 11/142,604

(22) Filed: May 31, 2005

(51) Int. Cl. G06F 9/44

(52) U.S. Cl. 717/130

(57) ABSTRACT

Techniques and tools relating to state-based source code annotation are described. For example, described techniques include flexible techniques for describing object states with annotations. In one aspect, properties of data structures in source code are described using state-defining code annotations. For example, specification structs can be used to describe an arbitrary set of states of objects, thereby improving the capabilities of the annotation language in terms of richness of program description. Specification structs also help to avoid annotating large numbers of individual fields in data structures by allowing several individual fields to be described by a single specification struct. Other aspects of a source code annotation language also are described.

### TECHNICAL FIELD

The invention relates generally to annotation of computer program code.

### BACKGROUND

As computer programs have become increasingly complex, the challenges of developing reliable software have become apparent. Modern software applications can contain millions of lines of code written by hundreds of developers, and each developer may have different programming skills and styles. In addition, because many large applications are developed over a period of several years, the team of developers that begins work on an application may be different than the team that completes the project. Therefore, the original authors of software code may not be available to error-check and revise the code during the development process. For all of these reasons, despite recent improvements in software engineering techniques, debugging of software applications remains a daunting task.

The basic concepts of software engineering are familiar to those skilled in the art. For example, FIG. 1 shows a technique 100 for developing a computer program according to the prior art. First, at 110, a program is created/edited by one or more developers. Then, at 120, the program is debugged (e.g., using a debugging tool). At 130, if the program contains bugs to be fixed, the editing/debugging cycle continues. When the source code for a program is determined to be sufficiently bug-free, the source code is compiled into executable code. FIG. 2 shows a block diagram of a system for compiling source code according to the prior art. A compiler 200 compiles source code written in a high-level language in source files 205 into executable code 210 for execution on a computer. The executable code 210 can be hardware-specific or generic to multiple hardware platforms. The compiler 200 can use, for example, lexical analysis, syntax analysis, code generation and code optimization to translate the source code into executable code. In addition, many compilers have debugging capabilities for detecting and describing errors at compile time.

The size and complexity of most commercially valuable software applications have made detecting every programming error in such applications nearly impossible. To help manage software development and debugging tasks and to facilitate extensibility of large applications, software engineers have developed various techniques of analyzing, describing and/or documenting the behavior of programs to increase the number of bugs that can be found before a software product is sold or used.

For example, source code can be instrumented with additional code to determine whether a particular program operation is safe. Or, program specifications can be written in specification languages that use different keywords and syntactic structures to describe the behavior of programs. Some specifications can be interpreted by compilers or debugging tools, helping to detect bugs that might not otherwise have been detected by other debugging tools or compilers.

Some specification languages define “contracts” for programs that must be fulfilled in order for the program to work properly. In general, a contract refers to a set of conditions. The set of conditions may include one or more preconditions and one or more postconditions. Contracts can be expressed as mappings from precondition states to postcondition states; if a given precondition holds, then the following postcondition must hold.

Preconditions are properties of the program that hold in the “pre” state of the callee—the point in the execution when control is transferred to the callee. They typically describe expectations placed by the callee on the caller. Callers are expected to guarantee that preconditions are satisfied, whereas callees are expected to be able rely on preconditions, but not to make any additional assumptions. Postconditions are properties of the program that hold in the “post” state of the callee—the point in the execution when control is transferred back to the caller. They typically describe expectations placed by the caller by the callee. Callees are expected to guarantee that postconditions are satisfied, whereas callers are expected to be able to rely on postconditions, but not to make any additional assumptions.

Specification languages tend to have shortcomings that fall into two categories. In some cases, specification languages are so complex that writing the specification is similar in terms of programmer burden to re-writing the program in a new language. This can be a heavy burden on programmers, whose primary task is to create programs rather than to describe how programs work. In other cases, specification languages are not expressive enough to describe the program in a useful way or to allow detection of a desirable range of errors.

Whatever the benefits of previous techniques, they do not have the advantages of the following tools and techniques.

### SUMMARY

Techniques and tools relating to a source code annotation language are described. For example, described techniques include flexible techniques for describing object states with annotations. In one aspect, properties of a data structure in source code are described using state-defining code annotations. For example, specification structs can be used to describe an arbitrary set of states of objects, thereby improving the capabilities of the annotation language in terms of richness of program description. Specification structs also help to avoid annotating large numbers of individual fields in data structures by allowing several individual fields to be described by a single specification struct. Other aspects of a source code annotation language also are described.

Additional features and advantages of the invention will be made apparent from the following detailed description which proceeds with reference to the accompanying drawings.

### BRIEF DESCRIPTION OF THE DRAWINGS

FIG. 1 is a flow diagram of a technique for creating a computer program according to the prior art.

FIG. 2 is a block diagram of a system for compiling source code according to the prior art.

FIG. 3 is a block diagram of a source code annotation system.

FIG. 4 is a flow chart showing a technique for annotating a data structure in source code with a specification struct.

FIG. 5 is a diagram of a buffer having a writableTo property and a readableTo property.

FIG. 6 is a code listing showing pseudocode illustrating an application of an maybeinit annotation on a buffer.

FIGS. 7A-B are code listings showing pseudocode with a definition of the data structure INTBUF and the functions “fillbuf” and “test_badfillbuf” and the corrected function “test_corrected_fillbuf.”

FIG. 8 is a code listing showing pseudocode for examples of specification structs.

FIG. 9 is a code listing showing pseudocode that illustrates an example of propagating annotations through pointer dereferences and struct field accesses.

FIGS. 10A-C are code listings showing pseudocode that illustrates an example of specification struct projection.

FIG. 11 is a code listing showing pseudocode with a definition of the data structure INTBUF that shows an example of an application of the whenState qualifier.

FIG. 12 is a code listing showing pseudocode for the specification struct VALID.

FIG. 13 is a code listing showing pseudocode for extending the specification struct VALID with an extra pattern for typedef T.

FIGS. 14A-B are code listings showing pseudocode for an implicit specification struct for a program struct T.

FIG. 15 is a code listing showing pseudocode for a struct S annotated with state(VALID).

FIGS. 16A-B are code listings showing pseudocode for the annotated function “malloc.”

FIGS. 17A-B are code listings showing pseudocode for the annotated function “memcpy.”

FIGS. 18A-B are code listings showing pseudocode for the annotated function “strncpy.”

FIG. 19 is a code listing showing pseudocode for an annotated version of the function “_read.”

FIG. 20 is a code listing showing pseudocode for a specification struct defining the state RPCinit.

FIGS. 21A-B are code listings showing pseudocode for extending the RPCinit specification for a program struct R.

FIG. 22 is a code listing showing pseudocode for macros used to translate MIDL prototype attributes into annotation language.

FIG. 23 is a code listing showing pseudocode for a definition of a MIDL conformant struct.

FIG. 24 is a code listing showing pseudocode for an annotated array member of a MIDL conformant struct and specification struct for a MIDL conformant struct.

FIG. 25 is a code listing showing a translation of a MIDL prototype of a function for sending a variable length array from a client to a server.

FIG. 26 is a code listing showing a translation of a MIDL prototype of a function for sending a variable length array from a server to a client, with size specified by the client.

FIG. 27 is a code listing showing a translation of a MIDL prototype of a function for sending a variable length array from a server to a client, with size specified by the server.

FIG. 28 is a code listing showing a translation of a MIDL prototype of a function for sending a variable length array from a server to a client with total memory size specified by client and element count specified by server-specified *pLength.

FIG. 29 is a code listing showing a translation of a MIDL prototype of a function for sending a variable length array from a client to a server, with total memory size specified by “Size” and element count specified by pLength.

FIG. 30 is a code listing showing a translation of a MIDL prototype of a function for sending a string from a server to a client, where string length should be smaller than “lSize.”

FIG. 31 is a code listing showing a translation of a MIDL prototype of a function for sending a string from a server to a client, where the server determines size.

FIG. 32 is a code listing showing a translation of a MIDL prototype of a function for sending a string from a client to a server.

FIG. 33 is a code listing showing a translation of a MIDL struct containing variable sized data.

FIGS. 34A-G are code listings showing a detailed example of a translation from MIDL to source code annotation language for RPC method LsarLookupNames2.

FIG. 35 is a block diagram of a suitable computing environment for implementing source code annotation language techniques and tools.

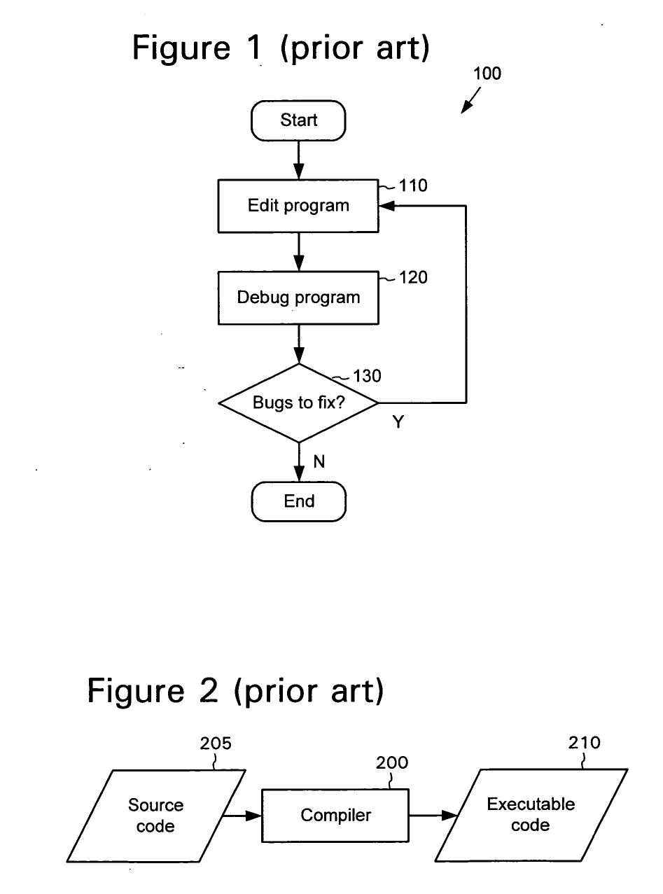

### DETAILED DESCRIPTION

The following description is directed to techniques and tools for implementing a source code annotation language. The techniques and tools allow simple yet expressive annotation of source code to assist developers in detecting bugs and developing reliable source code. For example, described techniques include flexible techniques for describing object states with annotations and other techniques and tools.

Various alternatives to the implementations described herein are possible. For example, techniques described with reference to flowchart diagrams can be altered by changing the ordering of stages shown in the flowcharts, by repeating or omitting certain stages, etc. As another example, although some implementations are described with reference to specific annotations, annotation methods, and/or algorithmic details, other annotations, annotation methods, or variations on algorithmic details also can be used. As another example, the implementations can be applied to other kinds of source code (e.g., other languages, data types, functions, interfaces, etc.), programming styles, and software designs (e.g., software designed for distributed computing, concurrent programs, etc.).

The various techniques and tools can be used in combination or independently. Different embodiments implement one or more of the described techniques and tools. Some techniques and tools described herein can be used in a source code annotation system, or in some other system not specifically limited to annotation of source code.

### I. Source Code Annotation System

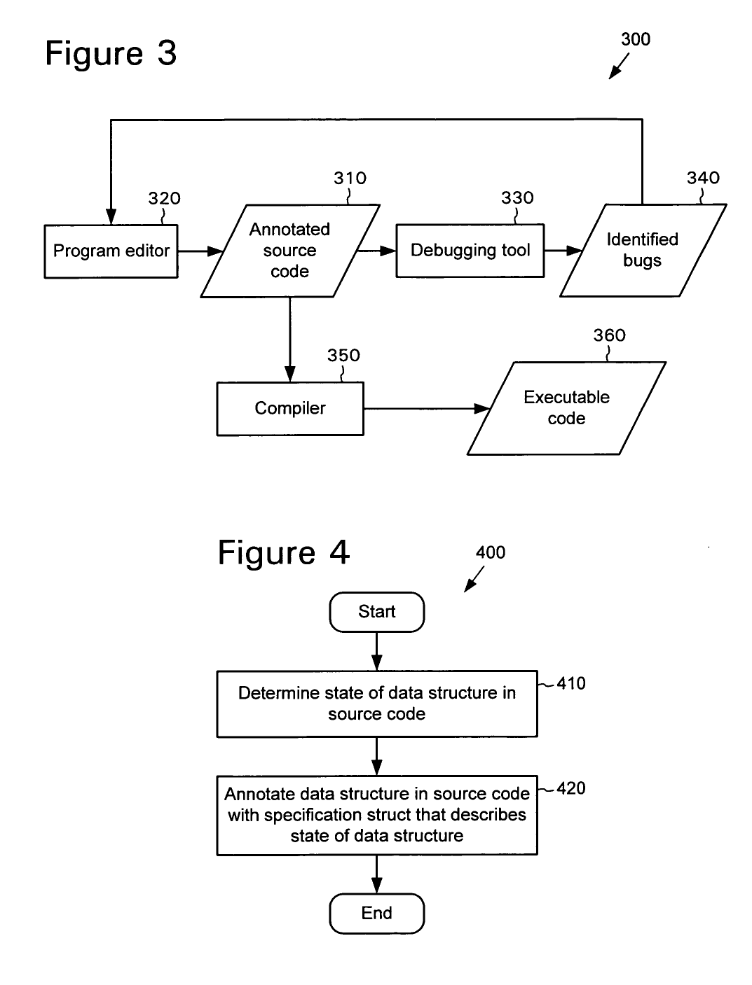

FIG. 3 is a block diagram of a source code annotation system 300. The system 300 is designed to produce annotated source code 310 useful for producing a high-quality final software product. For example, a developer uses a program editor 320 to create annotated source code 310 using a source code annotation language. In one implementation, annotations (e.g., state-based annotations) are placed in source code using a software tool designed for the purpose. Or, a software tool can be used to infer annotations in the source code. A developer can debug the annotated source code 310 using a debugging tool 330. The annotations in the annotated source code 310 allow detection of a broad range of bugs that may be present in the source code. From a list of identified bugs 340, a developer can edit the source code using the program editor 320. The annotations in the annotated source code 310 allow the iterations of the editing/debugging cycle to be more productive.

When debugging is complete, a developer uses a compiler 350 to compile the source code into executable code 360. For example, the compiler 350 may take annotations as input and perform further error-checking analysis at compile time. Or, the compiler 350 may ignore annotations in the annotated source code during compilation. The compiler 360 and the debugging tool 330 may alternatively be included in a combined debugging/compiling application.

### II. Source Code Annotation Language Features

Various implementations of a source code annotation language include one or more of the following features:
1. State-based source code annotations for describing states of objects and other data items, such as specification structs
2. Qualifiers for fields and indexing into arrays (dot and index);
3. Allowing pointers that may be null to be annotated as valid;
4. Conditional postconditions;
5. offset qualifier for specifying properties at a particular index in a buffer;
6. tainted property for specifying untrusted data;
7. formatstring property for annotating format parameters and associated arguments;
8. entrypoint property for specifying API entry-points in order to make tainted/untrusted assumptions;
9. range property for restricting the range of scalar values;
10. success(pred) qualifier for specifying the predicate pred that indicates when a function was successful;
11. Annotations can appear on functions rather than on specific parameters; the at qualifier allows tying the predicate to a particular parameter/result, and also serves as a general path qualifier, potentially replacing annotations such as deref, dot, index, and offset;

For example, FIG. 4 is a flow chart showing a technique 400 for annotating a data structure in source code with a specification struct. At 410, a state is determined for a data structure in source code. Then, at 420, an annotation (e.g., an annotation that takes a specification struct as an argument) is added to the source code to describe the state of the data structure. A specification struct can be designed to describe arbitrary states for a data structure. One example of a state of an object that could be described by a specification struct is a “valid” state that indicates that the data structure is in a usable state (e.g., as a precondition or postcondition of a call). Such annotations also can be used to define other states for data structures.

Various implementations also include other features described herein.

A. Annotation Overview

Annotations describe characteristics of and expected behavior of a program. The source code annotation language allows the placement of annotations on certain program artifacts called annotation targets. In one implementation of a source code annotation language, categories of annotation targets include global variables (or, “globals”), formal parameters of functions, return values of functions, user defined types (“typedefs”), and fields of program structs. Alternatively, the source code annotation language could allow the placement of annotations on other program artifacts, including call sites and arbitrary expressions. Annotations could be placed at arbitrary points in the control flow of the program to make assertions about the execution state, or on arbitrary data structures to make statements about invariants (i.e., properties of the data structure that always hold).

Implementations of the source code annotation language support a restricted but useful set of contracts to reduce complexity while allowing efficient descriptions of programs. The contracts include preconditions which hold on invocations of callees, and postconditions to be satisfied by callees on return. Annotations that describe preconditions and postconditions are useful, for example, for compile-time or run-time checkers that check the code of callees and callers and report violations of preconditions and postconditions.

In order to support contracts, the source code annotation language provides precondition and postcondition annotations. Precondition and postcondition annotations can be placed, for example, on individual parameters or on a return value. For example, in the function prototype

void func(_pre _deref _notnull int **ppvr)

the keyword sequence pre deref notnull is an annotation consisting of two qualifiers (pre and deref) and a property (notnull). The annotation is placed on the formal parameter ppvr of the function func. In general, any number of annotations may appear on an annotation target. (Pseudocode listings herein (and the accompanying Figures) indicate annotations with leading underline characters (e.g., _deref). Elsewhere in the text, annotations are generally indicated with boldface type.)

A detailed discussion of specific annotations (including pre, deref, and notnull) and annotation grammar follows.

1. Annotation Grammar

In general, an annotation comprises one or more annotation elements (which also can be referred to as keywords, tokens, etc.) in some sequence. Acceptable sequences of tokens vary depending on the annotation.

In one implementation, annotations are described as parameter annotations (annotations for program parameters) or field annotations (annotations for program struct fields). The source code annotation language includes annotation elements such as properties, qualifiers, and constructions (e.g., begin/end). A single annotation may consist of several annotation elements.

A grammar used in one implementation is shown below.

```
parameter-annot ::= [ pre | post [ (pred) ] basic_annot
field-annot ::= basic_annot
basic_annot ::= deref basic_annot
      | dot(field) basic_annot
      | index(number) basic_annot
      | offset(sizespec) basic_annot
      | begin basic_annot ⁺ end
      | atom_annot
atom_annot ::= p | except p
```

The parameter annotation (parameter-annot) grammar and the field annotation (field-annot) grammar each include a “basic” annotation element (basic-annot). The parameter annotation also includes an optional pre or post qualifier before the basic-annot element. The basic-annot element can be a qualifier followed by another basic-annot element (e.g., deref basic_annot, dot(field) basic_annot, etc.), a construction on another basic-annot element (e.g., begin basic_annot+end, etc.), or an atomic annotation element (atom_annot). An atomic annotation element is either a propertyp or a propertyp preceded by an except qualifier.

The begin/end construction allows grouping of annotations such that common qualifiers can be factored. It is also useful in other situations (e.g., when defining C++ macros).

In some implementations, Boolean predicates (pred) can be used in conditional postconditions. In some implementations, the language of predicates is defined by the grammar below:

| | |
|---|---|
| pred ::= | constant-bool (can be either true or false) |
| | \| location |
| | \| pred bop pred (bop can be && or \|\|) |
| | \| number rop number (rop can be <, <=, >, >=, ==, or !=) |
| | \| begin basic_annot ⁺ end |
| | \| atom_annot |

This annotation grammar can be varied as to annotations used, the optional nature of various elements, etc. Various implementations may omit certain annotations or include additional annotations.

An example of a grammar that uses different rules is described below in Section IV.

Other variations on this grammar also are possible.

Specific qualifiers and properties are described below.

2. Qualifiers

A qualifier is a prefix in an annotation that adds to the meaning of the annotation on an annotation target. Table 1 below lists and describes qualifiers in the annotation grammar described above.

TABLE 1
Qualifiers

| Qualifier | Meaning |
|---|---|
| pre | Prefixes an annotation to make it apply in the precondition state. |
| post [ pred ] | Prefixes an annotation to make it apply in the postcondition state. |
| | The optional boolean predicate pred makes the prefixed annotation |
| | conditional on pred. For example, a prefixed annotation conditional |
| | on the value of pred being true holds in the post state only if pred is |
| | also true. If no predicate is specified, it can default to true, making the |
| | postcondition unconditional. |
| deref | Annotates a pointer. The prefixed annotation applies one |
| deref(size) | dereference down in the type. For example, if p points to a buffer, |
| | then the prefixed annotation applies to all elements in the buffer. |
| | In some implementations deref takes an argument (size) that |
| | specifies the extent to which the prefixed annotation applies. size |
| | describes the indices for which the annotation applies. |
| dot(field) | Annotates a struct (or pointer to a struct). The prefixed annotation |
| | applies to the specified field only. |
| dot | Without a particular field, the prefixed annotation applies to all |
| | fields of the annotated struct. |
| index(number) | Annotates an array. The prefixed annotation applies to the |
| | specified indexed element only. Some possible valid number |
| | specifications are given below. |
| index | Without a particular index, the prefixed annotation applies to all |
| | valid indices of the annotated array. |
| offset(sizespec) | Annotates a pointer. If the prefixed annotation without the offset |
| | prefix would apply to a location L, then with the offset prefix it |
| | applies to the location L + sizespec (e.g., a byte offset). |

The pre and post qualifiers indicate whether a property is a precondition property or a postcondition property. In some implementations of the source code annotation language, properties of parameters apply in the “pre” state by default, whereas properties of the return value apply in the “post” state by default. The qualifiers pre and post are used to override these defaults.

The deref qualifier can be used to describe properties of objects that are reachable through one or more dereference operations on a formal parameter. In some implementations, reference parameters are treated like pointers. Annotations on a reference parameter apply to the reference itself; an explicit deref is used in order to specify properties of the referenced object. In some implementations, a dereferencing qualifier also supports more general access paths, such as field references. Field references are described in further detail below.

Requiring an explicit deref qualifier to specify properties for a referenced object allows placement of annotations on the reference itself (e.g., by withholding the deref qualifier in an annotation on a reference). This requirement allows the same annotations to be used whether a function receives a reference to an object or a pointer to the object. This requirement also ensures consistency with compilers that insert explicit dereference operations on uses of references. Alternatively, an implicit deref can be introduced on all annotations on the reference. The implicit deref treatment may be more natural for developers.

In some implementations, deref takes an argument (size) that specifies the extent to which the prefixed annotation applies. For example, deref(size) can take the place of a readableTo qualifier. If no size is given, the annotation applies to index 0. The readableTo qualifier, specific applications of deref(size), and possible interpretations of size are described in further detail below.

The offset qualifier facilitates annotating buffers that have internal structure that is not apparent from their type. The offset qualifier is described in further detail below.

Table 2 below describes the except qualifier, which can modify or disambiguate an entire sequence of annotations.

TABLE 2
The except qualifier

| Qualifier | Meaning |
|---|---|
| except | Given a set of annotations Q containing except maybeP, the |
| | effect of except maybeP is to erase any occurrences of |
| | property P or notP (explicit or implied) within Q at the |
| | same level of dereferencing as except maybeP, and to |
| | replace them with maybeP. |

The except qualifier is an override that is useful in situations where macros are used to combine multiple properties, and two macros that are placed on the same program artifact conflict on some property. This conflict situation occurs frequently in annotated code.

Qualifiers need not be limited to the set of qualifiers described above. Other implementations of the source code annotation language may employ additional qualifiers, omit some qualifiers, vary the definitions of certain described qualifiers, etc.

3. Properties

Properties are statements about the execution state of a program at a given point. Properties describe characteristics of their corresponding annotation targets in the program. The definitions of and grammar corresponding to arguments (e.g., size and location) need not be limited to the set of properties described herein. Versions of the source code annotation language may employ additional arguments, omit some arguments, vary the definitions of certain described arguments, etc. For example, one implementation of the source code annotation language does not give size as an element count.

In general, a property P has corresponding properties notP and maybeP. Where P indicates that a given property holds, notP indicates that the property does not hold, and maybeP indicates that the property may or may not hold. In one implementation, maybeP is used as a default property for un-annotated program artifacts.

Default properties can be applied recursively to all positions reachable by dereference operations and can give unambiguous meaning to un-annotated or partially annotated functions. To annotate programs, it is possible to use an annotation tool to insert default annotations for un-annotated program artifacts. The behavior of a particular checking tool may depend on whether an annotation that matches a default was placed explicitly in the code by a programmer. For such a checking tool, prior insertion of default annotations may lead to different program checking results. However, it may also be that annotation elements such as properties are not dependent on particular checking tools or particular uses (e.g., compile-time checking, run-time checking, test-generation, etc.).

Predefined properties relating two parameters (for instance, a buffer and its size) can be placed on one of the parameters while the name of the other parameter is given as an argument to the attribute.

The meanings of several properties are described below in Table 3.

TABLE 3
Properties

| Property | Meaning |
|---|---|
| init | Annotates any data item. States that the data item is initialized. Can be |
| | used in the form maybeinit to specify that certain fields need not be |
| | initialized. |
| null | Annotates a pointer. States that the pointer is null. |
| readonly | Annotates the contents of a location. States that the location is not |
| | modified after this point. If the annotation is placed on the precondition |
| | state of a function, the restriction only applies until the postcondition |
| | state. By default, all un-annotated locations are maybereadonly, that |
| | is, callers must assume the value may change. |
| checkReturn | Annotates a return value. States that the caller should inspect the return |
| | value. |
| state(S) | Annotates any data item. The properties of the data item are described |
| | by the specification struct S. Specification structs are described in |
| | detail below. |
| tainted(token) | Can be placed on any object. |
| | The annotated object is tainted in a certain way, and must be checked |
| | before being used in certain ways. |
| | token indicates how the object is checked (moved to an untainted state) |
| | and how it may be misused (e.g., passing a tainted object to a function |
| | with a precondition of untainted). Examples of token are “URL,” etc. |
| | A typical check function that removes possible taintedness will have a |
| | precondition of maybetainted and a postcondition of nottainted. The |
| | postcondition may be conditional (for instance, on the return value). |
| formatstring | Annotates a function parameter. The annotated argument is to be |
| (start, style) | interpreted as a format string. The start argument is a parameter index |
| | indicating the start of the parameters interpreted by the format string. |
| | The style argument indicates the style of format string, e.g., printf, or |
| | scanf. |
| entrypoint | Annotates a function/method. Indicates (e.g., to checking tools) that the |
| | annotated function is a programming interface (e.g., API) entry point. |
| | This is useful for inferring untrusted/tainted data. |
| range(min,max) | Annotates any scalar value and provides a range of validity. min and |
| | max are range-inclusive number expressions. |

As stated in Table 3, readonly annotates the contents of a location. For example, for a function interface foo(char *x),

foo(_deref _readonly char *x)

states that the contents of the char buffer pointed to by the formal parameter x cannot be modified.

Although readonly is similar in meaning to the language construct const, readonly can be used to annotate legacy interfaces on which “constness” cannot be specified without breaking applications. readonly is also sometimes more flexible than const (e.g., for describing constness of a recursive data structure parameter).

Basic properties need not be limited to the set of basic properties described above. Other implementations of the source code annotation language may employ additional properties, omit some properties, vary the definitions of certain described properties, etc. For example, one implementation of the source code annotation language uses only the basic properties null, readonly, and checkReturn.

a. Buffer Properties

Languages such as C and C++ have no built in concept of buffers or buffer lengths. However, annotations can be used to describe buffers. For example, the annotations offset, deref(size), readableTo and writableTo all have applications to buffers. Various implementations use one or more of these annotations to describe properties of buffers.

The writableTo and readableTo annotations state assumptions about how much space in a buffer is allocated and how much of a buffer is initialized. Such annotations include two main properties for buffers: the extent to which the buffer is writable (writableTo) and the extent to which the buffer is readable (readableTo). By stating assumptions about writableTo and readableTo extents at function prototypes, these annotations allow improved static checking of source code for buffer overruns.

As mentioned above, in some implementations deref(size) can take the place of a readableTo qualifier. The deref(size) qualifier takes an argument that specifies the extent to which the prefixed annotation applies. For example, the annotation deref(size) init specifies that a number (size) of items are initialized.

The writableTo and readableTo properties used in some implementations are described below in Table 4.

TABLE 4
The writableTo and readableTo properties

| Property | Meaning |
|---|---|
| writableTo(size) | Annotates a buffer pointer or array. If the buffer can be |
| | modified, size describes how much of the buffer is writable |
| | (usually the allocation size), provided the buffer is not null. For |
| | a writer of the buffer, this is an explicit permission to write up to |
| | size, rather than a restriction to write only up to size (Possible |
| | size descriptions are described below.) |
| readableTo(size) | Annotates a buffer pointer or array. The size describes how |
| | much of the buffer is readable, provided the buffer is not null. |
| | For a reader of the buffer, this is an explicit permission to read |
| | up to size, rather than a restriction to read only up to size. In |
| | some implementations, deref(size) can take the place of a readableTo |
| | qualifier. |

The writableTo property describes how far a buffer can be indexed for a write operation (provided that writes are allowed on the buffer to begin with). In other words, writableTo describes how much allocated space is in the buffer.

The readableTo property describes how much of a buffer is initialized and, therefore, how much of the buffer can be read. Properties of any elements being read can be described by annotations at the level of the element being read. Thus, it can be that elements in a buffer are maybeinit. In this case, although the buffer may be readable to size, what is being read may not be initialized. A permission to read up to a certain element also implies permission to write up to that element, unless the property readonly applies.

The offset qualifier (see Table 1 above) facilitates annotating buffers that, have internal structure that is not apparent from their type. For example, given a buffer that contains a leading 32-bit size followed by a null-terminated string, we can use offset to annotate the buffer's null-termination property as follows: offset(byteCount(4)) readableTo(sentinel(0)). This annotation states that at offset 4, the buffer is readable to a 0 (null). Without this offset, readableTo(sentinel(0)) would be satisfied by a 0 in the first four bytes alone, but it would say nothing about the string following the four bytes.

The writableTo and readableTo annotations are placed on the buffer pointer. For example, the annotation writableTo(byteCount(10)) can be placed on the buffer pointer for the function interface foo(char* buf) in the following manner:

foo(_writableTo(byteCount(10)) char* buf)

The annotation states that the pointer “buf” points to memory of which at least 10 bytes are writable.

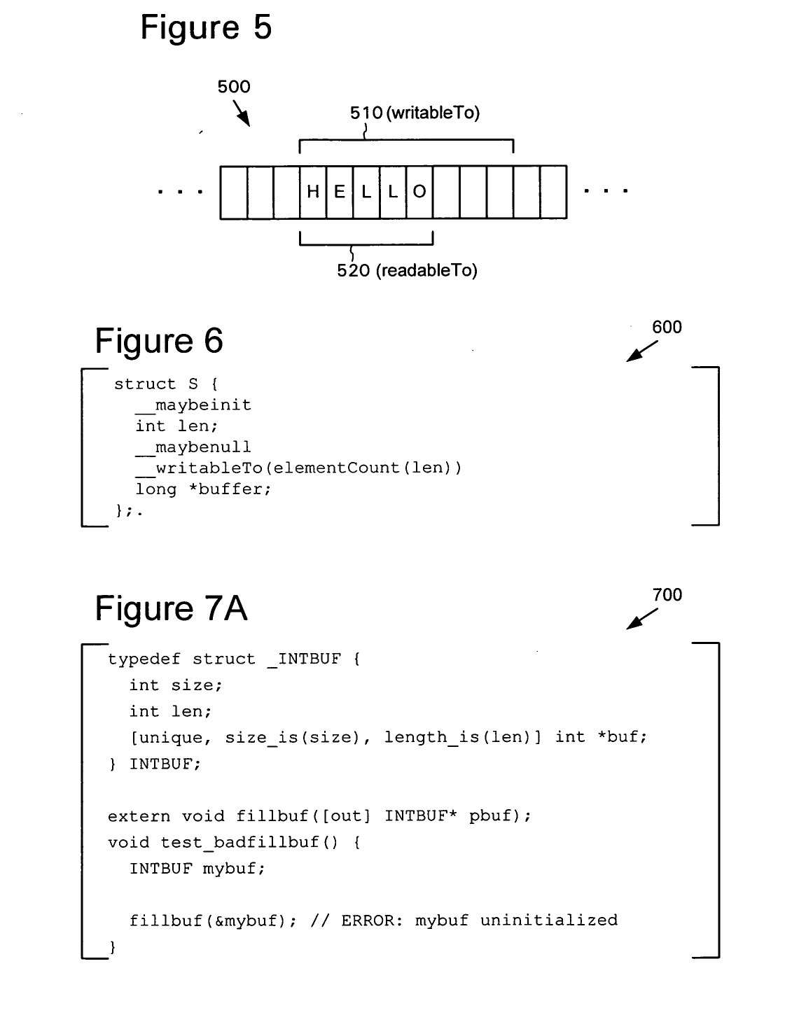

A buffer returned from an allocation function (e.g., a “malloc” function) starts with a known writableTo extent given by the allocation size, but the readableTo extent is empty. As the buffer is gradually initialized, the readableTo extent grows. For example, FIG. 5 is a diagram of a buffer 500 having a writableTo property and a readableTo property. The buffer 500 has allocated eight bytes allocated, indicated by the bracket labeled 510. The extent to which the buffer 500 as shown is currently writableTo is eight bytes. Part of the buffer 500 has been initialized and contains the characters H-E-L-L-O. The bytes containing these characters constitute the readableTo extent (indicated by bracket 520) of the buffer 500.

Optional special case for field initialization when length specification is used: It is possible that a program struct S such as the one shown in pseudocode 600 of FIG. 6 contains an apparent contradiction between the annotation maybeinit on the “len” field and the use of “len” in the element count of a buffer field. This contradiction can be resolved by assuming that the occurrence of a field name in a buffer length specification requires that field to be initialized in contexts where the length specification is in use. In the example shown in FIG. 6, the length specification is in use when the pointer is not null.

b. Size, Sizespec, Number, and Location

A size argument (e.g., of writableTo, readableTo, deref, etc.) can have several forms, or size specifications (sizespec). These are explained using the BNF grammar in Tables 5A-5C below. This grammar also describes location, which the property aliased (described below) also can take as an argument. For the purposes of this grammar, non-terminals are in italics, whereas literals are in non-italicized font.

TABLE 5A
size argument grammar

| | | | |
|---|---|---|---|
| size | ::= | [ pre \| post ]sizespec | The optional pre or post qualifier |
| | | | overrides the default store used to |
| | | | compute sizespec. |
| | | | The default store is the store in which |
| | | | the enclosing readableTo or writableTo |
| | | | annotation is interpreted. |

TABLE 5B
sizespec grammar

| | | | |
|---|---|---|---|
| sizespec | ::= | byteCount(number) | The size is given as a byte count. |
| | \| | elementCount(number) | The size is given as an element count. The size |
| | | | in bytes can be obtained by multiplying by the |
| | | | element size. |
| | \| | elementCount(number, | The size is given as an element count. elemsize |
| | | elemsize) | is a constant overriding the element size given by |
| | | | the C/C++ type. Useful for legacy interfaces |
| | | | with void*. |
| | \| | endpointer(location) | The size is given as an end pointer. The size in |
| | | | bytes can be obtained by subtracting the buffer |
| | | | pointer from location, and multiplying by the |
| | | | element size. |
| | \| | internalpointer(location) | The size is given as an internal pointer. |
| | | | endpointer and internalpointer provide the same |
| | | | information on readable and writable extent, but |
| | | | provide different information on the relative |
| | | | position of the two pointers. The distinction is |
| | | | useful when internalpointer is used as a |
| | | | refinement of the aliased property. |
| | \| | sentinel(constant-int) | The size is given by the position of the first |
| | | | occurrence of a sentinel value, starting at the |
| | | | element pointed to by the buffer pointer. |
| | | | constant-int is the sentinel value (usually 0). The |
| | | | size in bytes can be obtained by subtracting the |
| | | | buffer pointer from the pointer to the first |
| | | | occurrence of the sentinel value, adding 1, and |
| | | | multiplying by the element size. Implies that |
| | | | there is at least one occurrence of the sentinel |
| | | | value in the buffer. |

TABLE 5C
number grammar

| | | | |
|---|---|---|---|
| number | ::= | constant-int | |
| | \| | location | |
| | \| | number op number | op is either +, −, *, or /. |
| | \| | -number | |
| | \| | sizeof(C/C++-type) | The compile-time constant given by the |
| | | | C/C++ sizeof construct. |
| | \| | readableBytes(location) | The number is obtained by taking the readable |
| | | | bytes of location, which must denote a buffer. |
| | \| | writableBytes(location) | The number is obtained by taking the writable |
| | | | bytes of location, which must denote a buffer. |
| | \| | readableElements(location) | The number is obtained by taking the readable |
| | | | elements of location, which must denote a |
| | | | buffer. |
| | \| | writableElements(location) | The number is obtained by taking the writable |
| | | | elements of location, which must denote a |
| | | | buffer. |

TABLE 5D
location grammar

| | | | |
|---|---|---|---|
| location | ::= | variable | Usually a parameter. |
| | | ( pre\|post ) location | The pre/post qualification modifies the |
| | | | interpretation of the prefixed location, such that |
| | | | memory lookups implied by the location are |
| | | | performed either in the pre or the post state of a |
| | | | function call. |
| | | return | Special name; refers to the return value. |
| | | * location [ {const} ] | Dereference operation. The optional constant |
| | | | integer in braces states how many bytes to read in |
| | | | the dereference and overrides the implicit size |
| | | | provided by the type of location. |
| | | field | Refers to a field with an implicit struct, e.g., when |
| | | | referring to another field in a struct from within the |
| | | | struct |
| | | location .field | Refers to the particular field of the given location. |
| | | location [ number ] | Refers to the particular indexed field of the buffer |
| | | | or array denoted by location. |
| | | location ( +\|− ) const | Specifies a location obtained as an offset from |
| | | | another location. |
| | | ( location ) | Explicit parentheses around location expressions to |
| | | | disambiguate. |
| | | explicitarraylength | Special name; in the context of an embedded array, |
| | | | refers to the declared array size. |
| | | implicitloc | Special name; refers to the location being |
| | | | annotated. For example, if implicitloc appears |
| | | | inside a number inside a sizespec inside a |
| | | | readableTo annotation on a parameter p, then |
| | | | implicitloc refers to p. |
| | | | To determine the implicit location, offset prefixes |
| | | | (if present) are taken into account. |

The grammar in Tables 5A-5D presents several semantic possibilities for the size argument. However, not all of the semantic possibilities in this grammar are used. For example, one can create meaningless numbers by using readableElements to give meaning to a byteCount, and pre and post do not make sense on constant-int or in the context of field annotations. As another example, a return value can only be used with post.

Among the annotations described herein, there is no explicit annotation to indicate null-terminated buffers. In described implementations, null-terminated buffers are declared using the sentinel size specification. For instance, the property readableTo(sentinel(0)) describes a buffer that must contain a 0, and whose readable size extends at least as far as the buffer element that holds the first 0. Alternatively, an explicit annotation to indicate null-terminated buffers can be used.

Size specifications can be used to annotate buffers with an implicit structure that is not apparent in the buffer's declared type. For example, BSTR is a common string representation where the first byte indicates the number of characters following the size. A BSTR can be annotated as follows:

_readableTo(byteCount(1 + *_implicitLoc{1})

The annotation states that the buffer is readable to as many bytes as are stored at the head of the buffer+1 (for the head byte itself). Another way to state the BSTR property would be:

_offset(byteCount(1)) _readableTo(byte Count( *(_implicitLoc −
1){1} )

c. Aliased/Notaliased

The aliased(location) property is useful for transferring buffer properties from one pointer to another. The notaliased(location) property is useful for guaranteeing that two buffers are not aliased (i.e., that two buffers do not overlap). The aliased property is described in Table 6 below.

TABLE 6
The aliased property

| Property | Meaning |
|---|---|
| aliased(location) | Annotates a buffer pointer and states that the pointer |
| | points into the same logical buffer as location. |
| | The pointers need not be equal. |
| aliased | Annotates a pointer. States that the pointer could be |
| | aliased to other reachable objects. Can be used |
| | in the form notaliased to state that the pointer is |
| | not aliased with any other pointers reachable in |
| | the current dynamic scope. |

The sizespecs endpointer and internalpointer (see Table 5B above) can be used to refine the aliased annotation. aliased(q) on a pointer p states that p and q point into the same buffer. Additionally, readableTo(internalpointer(q)) on a pointer p states that p is less than or equal to q.

B. States for Data Structures

Specifying detailed properties about individual fields of structures and pointed-to structures can add to the volume of annotations needed to describe such structures and can be tedious. Accordingly, described techniques and tools allow programmers greater flexibility in describing properties of such data structures. For example, we can specify that a particular data structure is in state S by adding the annotation state(S). Annotations called specification structs can be used to describe states of more complex data structures. (Specification structs are distinguished from structs in C/C++ program source code, which are referred to herein as “program structs.”) Further, a qualifier called whenState can be used to indicate that an annotation on a field of a program struct applies in some state.

One state that is often of interest is the “valid” state, which indicates usability of the annotation target. (Usability and the “valid” state are describe in further detail in Section II.C, below.) Although a primitive property valid can be used to indicate whether an annotation target is in a valid state, using primitive properties in this way to describe states is limited to whatever such primitives are predefined in the annotation language. Annotations such as state(S) and specification structs allow not only distinguishing valid from non-valid data items, but distinguishing an arbitrary set of states of a data item.

1. Specification Structs

A specification struct is a struct that is used as an annotation. Specification structs provide flexibility for describing program states. For example, specification structs can be used to describe properties of entire program structs or one or more fields of a program struct.

In some implementations, the following annotations are used with specification structs.

TABLE 7
Annotations for specification structs

| Annotation | Meaning |
|---|---|
| spec | Annotates a struct definition and marks it as a specification |
| | struct. |
| specoverride(S) | Annotates a struct definition and marks it as a specification |
| | struct. It inherits all definitions from specification struct S, but |
| | explicit field definitions override inherited definitions. |
| specprojection(S) | Annotates a struct definition and marks it as a specification |
| | struct. Any listed fields without annotations obtain their |
| | annotations from specification struct S. Any listed fields with |
| | annotations obtain only those annotations, and no annotations |
| | inherited from S. Any non-listed fields have no annotations. |
| pattern | Used on field declarations in specification structs to mark the |
| | field as a type pattern. A type pattern applies to any field with |
| | the given type. Typedef names are matched by name, not by structure. |
| | Special predefined typedefs (e.g., |
| | SAL_ANY_POINTER, SAL_ANY_SCALAR, |
| | SAL_ANY_STRUCT, SAL_ANY_ARRAY) can be used as |
| | wild card matches for the corresponding class of types. |

These annotations are described in further detail below.

Annotations used with specification structs need not be limited to the set described above. Other implementations may use additional annotations, omit some annotations, vary the definition of annotations, etc.

a. Specification Struct Example

The following example shows a possible application of specification structs. The example uses a remote procedure call (RPC) stub interface and illustrates different properties that are supposed to be true about a data structure (INTBUF) being passed through an RPC stub.

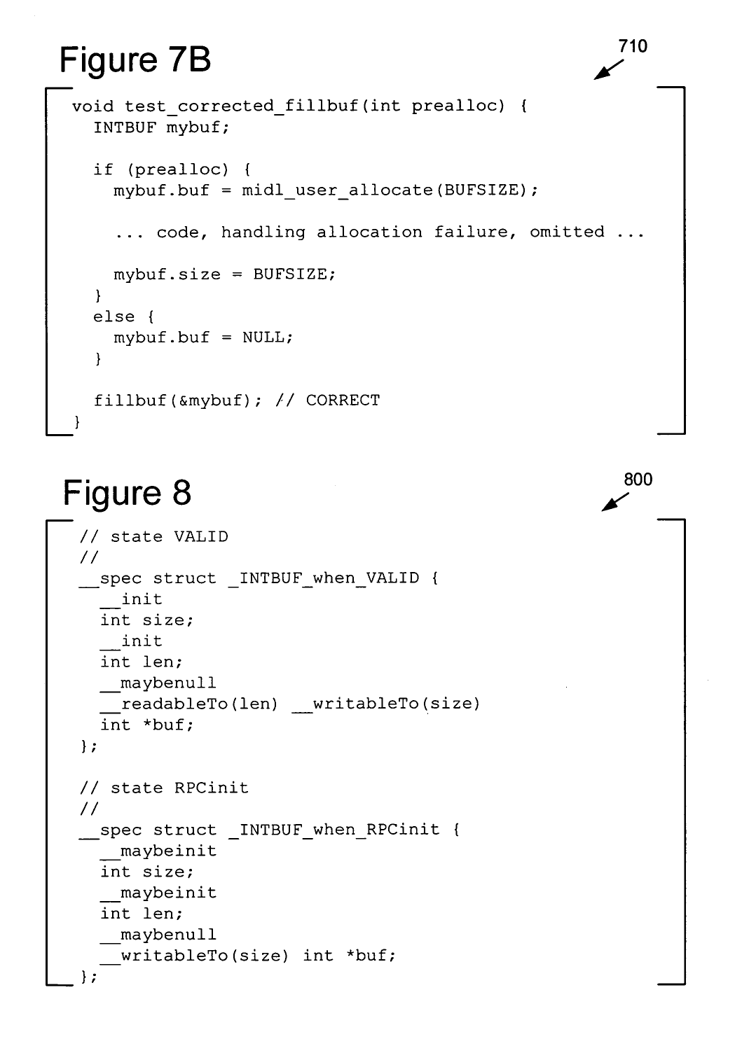

The example is illustrated with reference to FIGS. 7A and 7B. FIG. 7A is a code listing showing pseudocode 700 with a definition of the data structure INTBUF and the functions “fillbuf” and “test_badfillbuf.” If “fillbuf” is an RPC generated stub, the function “test_badfillbuf” in pseudocode 700 is incorrect. An RPC “out” parameter cannot in general point to uninitialized memory, since the client side stub tries to reuse memory already allocated on the client side. Thus, the stack allocated variable “mybuf” likely has a random bit pattern and the client side RPC stub will misinterpret the uninitialized pointer in “mybuf.buf” as a valid pointer for the purpose of deciding whether or not to reuse client side memory.

The problem in “test_badfillbuf” can be fixed by either pre-allocating the buffer and initializing the “size” field to correctly reflect the buffer size, or by initializing the pointer “buf” to null and letting the RPC client stub allocate the buffer memory. FIG. 7B is a code listing showing pseudocode 710, which includes the corrected function “test_corrected_fillbuf.”

FIGS. 7A and 7B show that RPC “out” parameters cannot contain uninitialized pointer fields on entry to a client stub. This is different from typical “out” parameters in non-RPC calls, which are assumed to contain random data on entry.

FIGS. 7A and 7B show that there are two distinct possible states for the program struct INTBUF. One state, which can be referred to as the VALID state, is the state of INTBUF when returned from an “out” position, or the state it has to be in when passed as an “in” parameter. Suppose the VALID state for INTBUF means that if the field “buf” is non-null, then it points to memory that is correctly described by the “size” and “len” fields. The second state, which can be referred to as the RPCinit state, is the state needed on entry to a client stub when passed as an “out” parameter. In the RPCinit state, either the field “buf” is null and the “size” field may be uninitialized, or the field “buf” contains a valid pointer and its size is described by the “size” field. In both cases, the field “len” may be uninitialized.

The program struct INTBUF can be described using annotations in the two states identified above, namely, state VALID and state RPCinit. The annotation elements we use to describe these states in this example are INTBUF_when_VALID and INTBUF_when_RPCinit, as shown in pseudocode 800 of FIG. 8.

INTBUF_when_VALID and INTBUF_when_RPCinit are called “specification structs” since they provide annotations for the fields of program struct INTBUF in state VALID and state RPCinit, respectively. Specification structs can be distinguished from program structs with the spec annotation.

Given these descriptions of the properties of data structures, we can specify at which program point a data structure conforms to a particular description. For the “fillbuf” example, we can annotate the parameter as follows:

```
extern void fillbuf( _notnull
    _pre _deref _state(INTBUF_when_RPCinit)
    _post _deref _state(INTBUF_when_VALID)
    INTBUF* pbuf);
```

These annotations say that the pointer must not be null, that on entry the state of the data structure is as described by specification struct INTBUF_when_RPCinit, and that on exit the data structure is described by specification struct INTBUF_when_VALID.

The following sections describe tools and techniques for describing different states of data structures, including how to factor common states and how to provide defaults.

2. Naming Conventions for States of Data Structures

As mentioned above, we can specify that a particular data structure is in state S by adding the annotation state(S). For example, we can specify that a particular data structure is in state RPCinit by adding the annotation state(RPCinit). In some implementations of a source code annotation language, an annotation state(X) can be associated with specification structs via the following name convention: if the annotated type is T, then we first check if there is a specification struct called T_when_X. This allows a specific specification struct to apply to a particular data structure. If no such specification struct exists, we use a specification struct called X Falling back on X is useful for obtaining default specifications that apply to many different data structures.

The next section explains how the use of type patterns allows writing specification structs that apply to many different data structures.

3. Type Patterns in Specification Structs

Type patterns facilitate describing properties of many different data structures using a single specification struct. With type patterns, we can provide annotations for any field that has a particular type.

A type pattern is a field declaration with the following form:

pattern [annotations] type fieldname

The pattern annotation distinguishes the pattern from actual field specifications. type is the actual type pattern. Any C/C++ type can serve as a type pattern. fieldname (which could also be referred to as a pattern name) names the pattern.

For example, the specification struct NonNullLPWSTR below specifies that all fields of type LPWSTR should not be null.

```
_spec struct NonNullLPWSTR {
    _pattern
    _notnull
    LPWSTR wstringdefault;
};
```

In the specification struct NonNullLPWSTR in this pseudocode, LPWSTR is the type pattern and wstringdefault is the name of the pattern.

Other type patterns can be written in other ways. For example, there is no standard way in C to express all pointer types as a single C type. Accordingly, for a pattern that covers all pointer types, built-in typedefs can be used. For instance, we can define a specification struct that states that all pointer fields are not null in the following way:

```
_spec struct NonNullPointers {
    _pattern
    _notnull
    SAL_ANY_POINTER pointerdefault;
  };
```

In this pseudocode, SAL_ANY_POINTER is a predefined typedef in the source code annotation language that acts as a type pattern for all pointer types. Applying this specification struct to the INTBUF program struct from an earlier example (see, e.g., FIG. 7A), we would obtain a specification that states that field “p.buf” is not null.

void Test(_deref _state(NonNullPointers) _INTBUF *p);

Predefined typedefs for primitive type patterns in one implementation are listed below in Table 8.

TABLE 8
Type patterns

| Pattern | Matches |
|---|---|
| SAL_ANY_POINTER | Matches any pointer type. |
| SAL_ANY_SCALAR | Matches any scalar type. |
| SAL_ANY_STRUCT | Matches any program struct type. |
| SAL_ANY_ARRAY | Matches any array type. |

The type patterns shown in Table 8 are not required. Other type patterns can be used, or one or more of these type patterns can be omitted.

4. States for Arbitrary Types

In addition to states for describing properties of program structs, states for describing properties of other types (e.g., pointers, scalars, etc.) are described. For example, the patterns introduced above allow interpretation of states of data types other than program structs. For example,

_state(NonNullPointers) int *pInt;

applies the state NonNullPointers to a pointer “pInt” of type int *. This can provide one or more annotations for “pint” by finding a pattern in NonNullPointers that matches the type int *. In this case, the pattern in NonNullPointers is SAL_ANY_POINTER, and the annotation obtained for “pint” is notnull. Patterns also can be used for types other than int *. Or, states for such other types can be described in other ways.

5. Recursive Propagation

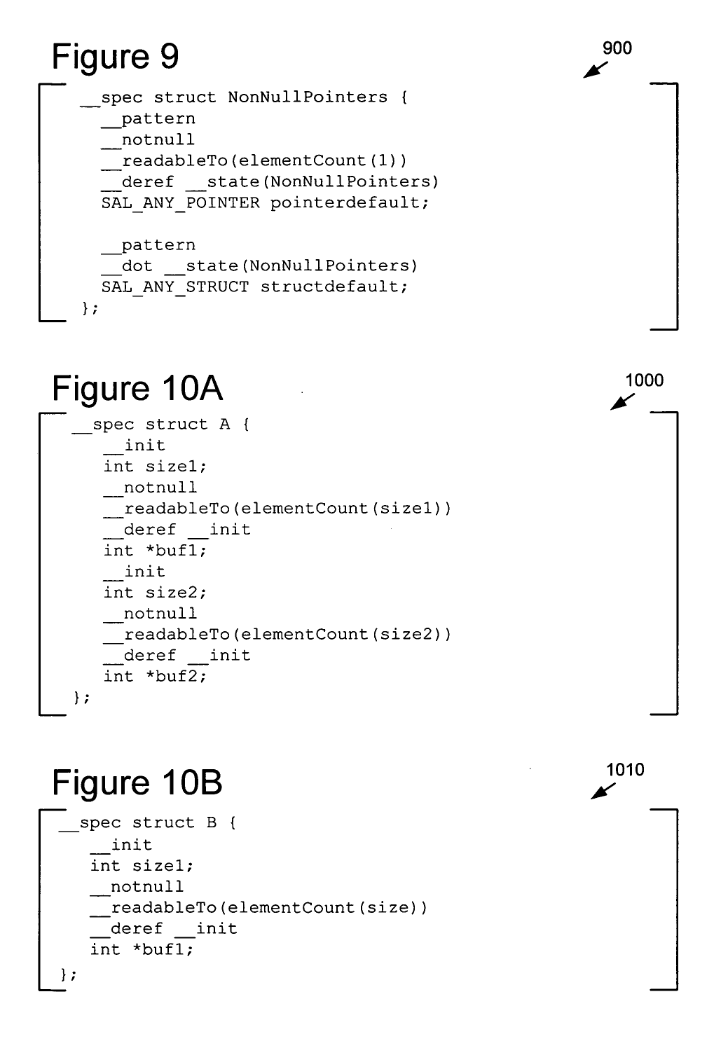

Annotations such as those shown in pseudocode 900 of FIG. 9 can be used to propagate annotations through pointer dereferences, field accesses, etc. We have described the state NonNullPointers as annotating a single level in a program struct. For example, the declaration

_state(NonNullPointers) INTBUF *pbuf;

indicates that “pbuf” is not null, but it does not describe pbuf->buf.

In FIG. 9, two annotations are added to the SAL_ANY_POINTER pattern: readableTo(elementCount(1)) and deref state(NonNulPointers). A pointer can be dereferenced at index 0, and the dereferenced value has the properties of state(NonNullPointers). A new pattern for SAL_ANY_STRUCT is added that states that the properties of a field (dot) are those of state NonNullPointers. These two patterns propagate the state NonNullPointers through pointer dereferences and through program struct field accesses.

From the example where INTBUF *pbuf is annotated with state(NonNullPointers), we obtain the annotations shown below in Table 9:

TABLE 9
Examples of Propagated Annotations

| Position in | | | |
|---|---|---|---|
| Type | | | |
| Structure | Spec Struct | Field Used | Interpretation |
| * | NonNullPointers | NonNullPointers. | _notnull _readableTo(1) |
| | | pointerdefault | _deref _state(NonNullPointers) |
| INTBUF | INTBUF_when_Non | <does not exist> | Use non-specific |
| | NullPointers | | specification struct |
| INTBUF | NonNullPointers | NonNullPointers. | _dot |
| | | structdefault | _state(NonNullPointers) |
| .buf | NonNullPointers | NonNullPointers. | _notnull |
| | | pointerdefault | _readableTo(1) |
| | | | _deref |
| | | | _state(NonNullPointers) |
| int | NonNullPointers | <no pattern | <none> |
| | | matches scalars> | |
| .size | NonNullPointers | <no pattern | <none> |
| | | matches scalars> | |
| .len | NonNullPointers | <no pattern | <none> |
| | | matches scalars> | |

6. Overriding Existing Specification Structs

Often, states differ only in a few fields or patterns. To define a new specification struct based on an existing specification struct SPEC, a specification struct can be annotated with specoverride(SPEC) instead of just the annotation spec. With this annotation, fields provided explicitly in the new specification struct replace the corresponding ones from SPEC; any field not explicitly defined obtains its definition from SPEC. For example, the following variation of the NonNullPointers specification annotates scalars with init.

```
_specoverride(NonNullPointers) struct NonNullAndInit {
    _pattern
    _init
    SAL_ANY_SCALAR scalardefault;
  };
```

Other kinds of overrides also can be used.

7. Projections of Existing Specification Structs

Sometimes it is convenient to project properties of some fields out of an existing specification struct without repeating those properties explicitly, and without making annotations on other fields. To support this style, we can use the annotation specprojection(SPEC) on a specification struct. With this annotation, a field explicitly listed in the annotated specification struct obtains corresponding annotations from SPEC; non-declared fields have no annotation.

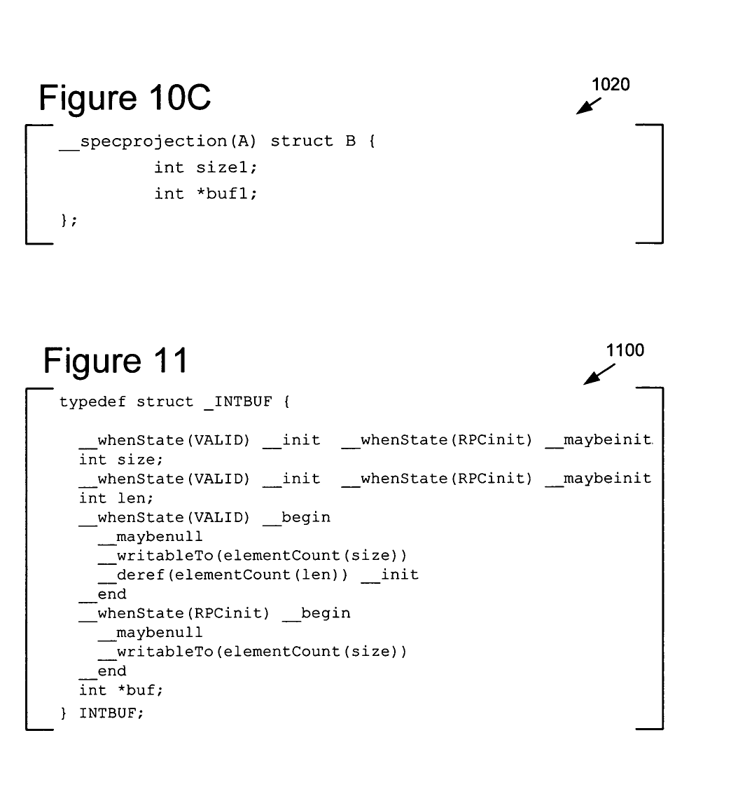

For example, consider a specification struct A with two buffer fields and two corresponding buffer sizes, as shown in pseudocode 1000 in FIG. 10A. Suppose that a function “init2” initializes the second buffer, and expects only the first buffer to be initialized. An explicit new specification struct B could be written that contains only the annotations for fields “size1” and “buf1,” but that would require duplicating the annotations of fields “size1” and “buf1” in both specification structs A and B, as shown in pseudocode 1010 in FIG. 10B.

In this case a projection can be used, as shown in FIG. 10C. The example projection shown in FIG. 10C (using the annotation specprojection) defines specification struct B to contain only the annotations on fields “size1” and “buf1” from specification struct A.

Other kinds of projections also can be used.

8. whenState(S)

The qualifier whenState can be used to annotate a field of data structure. For example, in one implementation whenState(S) indicates that the qualified field annotation applies only in state S. The whenState qualifier makes it possible to describe field invariants for particular states without having to define specification structs.

In implementations where the whenState qualifier is available to be used, field annotations without a whenState qualifier apply to all states. Alternatively, omission of a whenState qualifier could indicate that a field annotation applies to a default state (e.g., a “valid” state).

Pseudocode 1100 in FIG. 11 shows an example of an application of the whenState qualifier to describe the INTBUF data structure mentioned above without specification structs. The whenState(VALID) annotation in pseudocode 1100 is used to specify that in state VALID, fields “size” and “len” (both integers) are initialized, and that field “buf” could be null. If it is not null, then there are “size” elements that are writable, and “len” elements that are initialized. The whenState(RPCinit) annotation in pseudocode 1100 is used to indicate that, in the RPCinit state, “size” and “len” don't have to be initialized, and that field “buf” could be null, but if it is not null, then it is writableTo for “len” elements. The annotations imply that field “len” is initialized if “buf” is non-null in state RPCinit.

C. Validity

The usability of a data item (e.g., an object, data structure, etc.) usually depends on its declared C/C++ type. For instance, a usable program struct should have initialized fields, so that field accesses yield meaningful results. Similarly, usable LPSTRs should be null-terminated buffers. Usability can vary depending on context. For example, in some situations it is important to determine whether something is usable in a “pre” state, while in other situations it is important to determine whether something is usable in a “post” state. As another example, an “in” parameter should be usable in the “pre” state of the function, and an “out” parameter should be usable in the “post” state of the function.

Data items are not always usable. A data item that is not usable cannot be relied upon. For instance, if an object of a user-defined type is expected to be a null-terminated string, the object may not be usable when freshly allocated or when passed in from an un-trusted source.

In one implementation, the source code annotation language uses the annotation valid to state that a data item is usable. A data item annotated with property valid represents a common case, that is, a normal state of the data item. The normal state of a data item of a particular type may vary depending on implementation. For example, in one implementation, null pointers are not valid. In other implementations, valid pointers can be maybenull.

Although valid can be used as a primitive property, in some implementations the state(S) annotation is used together with a specification struct called VALID, to indicate that an annotation target is usable.

In the example shown in FIG. 12, specification struct VALID uses the type patterns SAL_ANY_SCALAR, SAL_ANY_POINTER, SAL_ANY_STRUCT, and SAL_ANY_ARRAY to provide annotations for arbitrary fields and types. The constant explicitarraylength is used to refer to the statically declared size of an array. It can be used in length specifications. The specification struct VALID can be used, for example, to propagate VALID recursively to targets of pointers, program struct fields, and array elements.

Using these definitions, the primitive property valid can be represented by (or replaced by) state(VALID).

1. Typedefs and VALID

Annotations also can be placed on typedefs. For example, the Microsoft Windows typedef LPSTR can be annotated to encode the fact that valid LPSTRs are null-terminated buffers, as follows:

typedef _readableTo(sentinel(0)) char *LPSTR;

The set of annotations corresponding to a valid data item can be derived transitively through typedefs in the source code. For example, valid LPSTRs can have the annotation readableTo(sentinel(0)), as well as all of the annotations on data items of type char *. In some implementations, readableTo can be replaced with deref(size).

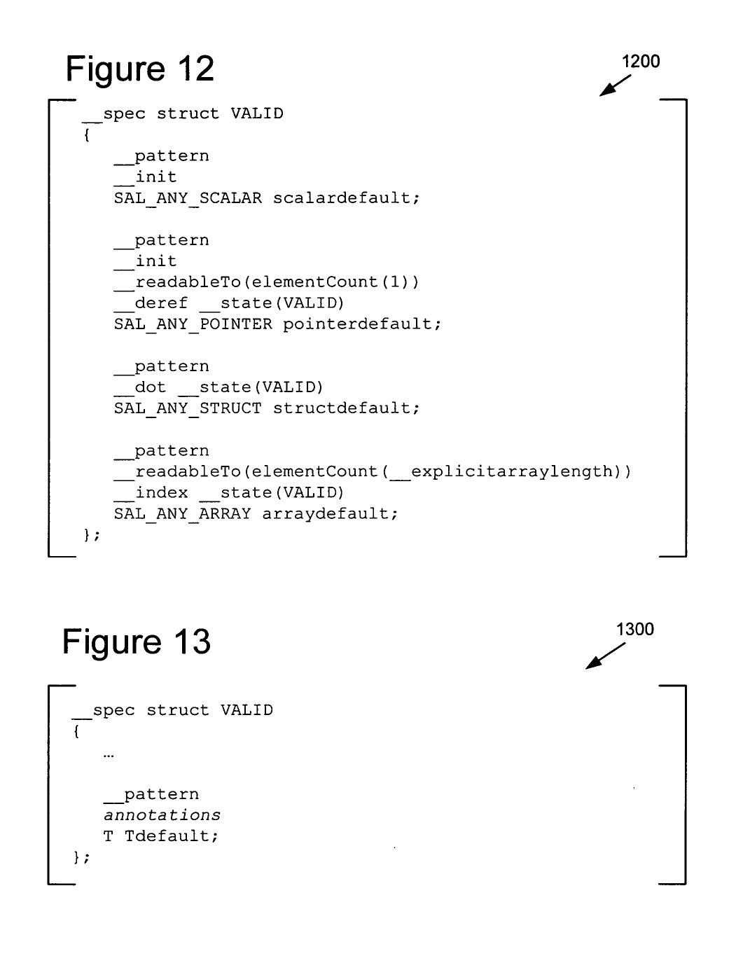

Annotations on typedefs make it possible to extend the state VALID to abstract types. Conceptually, each typedef T extends the VALID specification with an extra pattern of the form shown in pseudocode 1300 in FIG. 13. This pattern matches types with the typedef T and annotates them with the annotations specified in the typedef.

2. Overriding the Declared Type

In some cases, an interpretation of valid derived from the declared C/C++ type of a parameter may be inappropriate. This may be because the C/C++ declared type on a function signature is imprecise, outdated, or otherwise wrong, but cannot be changed.

In some implementations, the typefix property can be used to override the declared C/C++ type. The interpretation of valid is obtained from the type given by the typefix instead of the declared C/C++ type. typefix can be used in conjunction with annotations on typedefs to customize the notions of validity associated with parameters. The meaning of the typefix property is described in Table 10 below.

TABLE 10
The typefix property

| Property | Meaning |
|---|---|
| typefix(ctype) | Annotates any data item. States that if the data item is |
| | annotated as valid, then it satisfies all of the properties |
| | of valid ctype data items. ctype must be a visible |
| | C/C++ type at the program point |
| | where the annotation is placed. |

For example, legacy code may use void * or char * types for null-terminated string arguments. To take advantage of the valid property, it is useful to typefix these types to a type with a null-termination characteristic such as LPSTR. The following example describes this use of the typefix property:

void use_string(_typefix(LPSTR) _valid void *stringarg)

3. Annotations on Program Structs

As mentioned above, a specification struct called VALID captures common properties of a type. On the other hand, it is natural to annotate a program struct definition with the annotations that are to hold in a usable state of the program struct. Therefore, in some implementations, the following convention is provided: Each program struct S (not a specification struct), implicitly defines a specification struct with name S_when_VALID; given an existing specification struct VALID, the implicit specification struct S_when_VALID overrides VALID.

The implicitly defined specification struct contains any field definitions of S that have annotations. For non-annotated fields, the annotations from the applicable patterns in VALID apply. This convention makes it convenient to put annotations for the VALID state directly into the definition of the program struct, without the need to specify a separate specification struct for the VALID case.

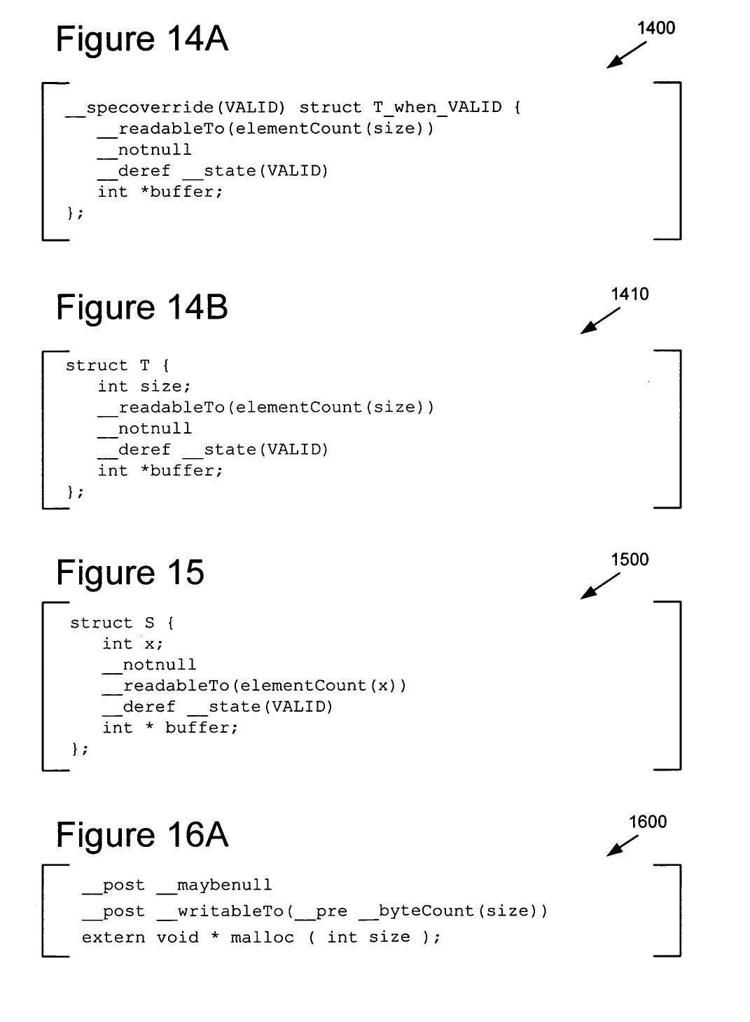

For example, pseudocode 1400 in FIG. 14A shows the implicit specification struct for a program struct Tshown in pseudocode 1410 in FIG. 14B. The use of specoverride provides default annotations for un-annotated fields from VALID. Thus, it is not necessary to annotate the scalar field “size” with init, since it will obtain that annotation from the “scalardefault” pattern of VALID. Also, the naming convention of the form <type>_when_<state> for specification structs makes annotations more readable without having to redundantly name the specification struct by including the type name. Thus, in this example,

_state(VALID) struct T

is equivalent to

_state(T_when_VALID) struct T.

D. Interpretations of State Annotations

The following examples illustrate how state(S) predicates are interpreted in some contexts. In general, given a specification struct A and a type structure T annotated with state(A), positions in the type structure are interpreted as being annotated with the corresponding positions in the specification struct.

1. int ** in State VALID

Table 11 shows interpretations of the statement: _state(VALID) int **;

TABLE 11
int ** in State VALID

| Position | | | |
|---|---|---|---|
| in Type | Spec | | |
| Structure | Struct | Field Used | Interpretation |
| * | VALID | VALID.pointerdefault | _readableTo(1) |
| \| | | | _deref _state(VALID) |
| * | VALID | VALID.pointerdefault | _readableTo(1) |
| \| | | | _deref _state(VALID) |
| int | VALID | VALID.scalardefault | _init |

2. Program Struct in State VALID

Referring to FIG. 15, given the definition of struct S in pseudocode 1500, Table 12 shows interpretations of the statement: _state(VALID) struct S *;. Note how in this example the separation of the state name from the specification struct name enables the interpretation to pick up the specification struct most appropriate for any particular struct type during the recursive unfolding.

TABLE 12
Struct S in State VALID

| Position in | | | |
|---|---|---|---|
| Type | Specification | | |
| Structure | Struct | Field Used | Interpretation |
| * | VALID | VALID.pointerdefault | _readableTo(1) |
| \| | | | _deref _state(VALID) |
| S | (implicit) | | |
| | S_when_VALID | | |
| \|--- x | S_when_VALID | VALID.scalardefault | _init |
| | | | (inherited from VALID) |
| \|--- buffer | S_when_VALID | S_when_VALID.buffer | _readableTo(elementCount(x)) |
| * | | | _deref _state(VALID) |
| \| | | | |
| int | VALID | VALID.scalardefault | _init |

E. Success and Failure in Functions

Many functions fall in the category of having a successful outcome that can be distinguished from some failure outcomes. In some implementations, it is desirable to specify how a function indicates success and what postconditions hold in a success case. An expectation that unqualified postconditions on functions are supposed to hold in all outcomes is rarely convenient.

Accordingly, some implementations use a success annotation that can be declared on a function. If a function is annotated with a success condition, the unqualified postconditions apply only in the success case. A failure qualifier also can be used to abbreviate the conditional postcondition of the negation of the success condition.

Table 13 shows annotations relating to success and failure conditions.

TABLE 13
Annotations Relating to Success and Failure Conditions

| Annotation | Meaning |
|---|---|
| success [ ( pred ) ] | Declares the success predicate pred that indicates in the post |
| | condition whether or not the function was successful. This is used in |
| | conjunction with post annotations on parameters and results of this |
| | function to make these post conditions apply only to the success |
| | case. (See description of post below.) |
| post [ ( pred ) ] | Prefixes an annotation to make it apply in the postcondition state. |
| | The optional boolean predicate pred makes the prefixed annotation |
| | conditional on pred. In other words, the annotation only holds in the |
| | post state if pred is also true. If no predicate is specified, it defaults |
| | to true, making the postcondition unconditional, except in the case |
| | where the annotated function has a success(pred) declaration. In that |
| | case, post P is equivalent to post(pred) P. |
| failure | Prefixes an annotation to make it apply in the postcondition state |
| | whenever the success condition of the function is not met. Can only |
| | be used if the function on which this qualifier appears has a |
| | success(S) annotation. In that case, failure P is equivalent to |
| | post(!S) P. The annotation itself can appear wherever the post |
| | qualifier can appear. |

Checkers supporting these annotations may use defaults for functions returning particular types used for error indication. For example, functions with a return type of HRESULT could be interpreted as having the implicit annotation success(return=S_OK).

Alternatively, success or failure annotations can be omitted. Without success or failure annotations, unconditional postconditions can still apply to all outcomes.

### III. EXAMPLES

This section shows examples of how source code can be annotated using described implementations of the source code annotation language. For example, some examples show annotations on prototypes of buffer-related functions from C/C++. Other examples show translations of Microsoft® Interface Definition Language (MIDL) attributes into source code annotation language.

The ordering and composition of annotations can vary from those shown in these examples.

A. Examples: Buffer-Related Functions

This section shows examples of how prototypes of some well-known buffer-related functions could be annotated in some implementations. The ordering and composition of annotations can vary from those shown in these examples.

For each prototype, we provide a verbose form, in which default annotations are made explicit, and a concise form, in which default annotations are omitted. In these examples, default annotations are filled in as follows. Annotations on results apply in the post state. In some implementations, properties not explicitly stated are maybe. The byteCount(size) on the result is actually interpreted in the post state, because writableTo applies to the post state. Unless explicitly stated, sizes are interpreted in the same state as the annotation on which they appear. In this example, the pre and post byteCount(size) have the same interpretation.

1. malloc

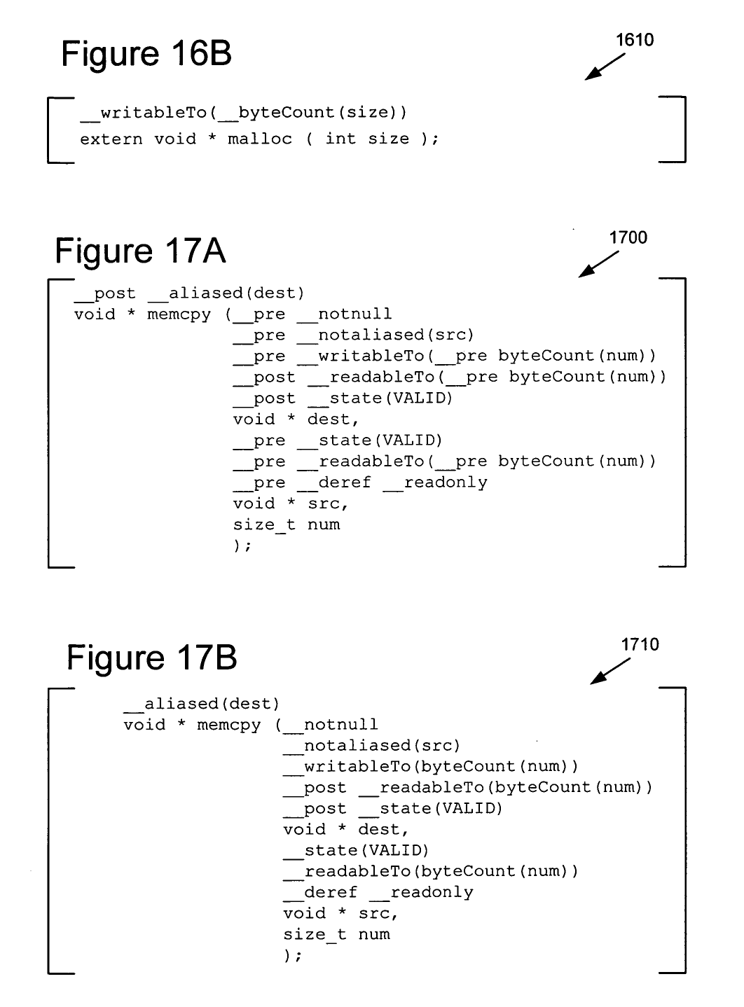

FIG. 16A shows pseudocode 1600 for an annotated version of the function malloc. The annotations on the result of the function malloc specify that the returned pointer could be null, but if it is non-null, it is writable to the byte count given by the parameter size. In this example, the annotations do not state anything about whether the memory pointed to by the return value is initialized, or whether the memory later needs to be freed. The concise annotations for malloc are shown in pseudocode 1610 in FIG. 16B.

2. memcpy

FIG. 17A shows pseudocode 1700 for an annotated version of the function memcpy. For memcpy, the annotations on the parameter “dest” state that on entry, it is a buffer writable to byteCount(num), and on exit, it is readable to byteCount(num), and in state VALID. The annotations on the parameter “src” state that on entry the buffer is in state VALID and readable to byteCount(num), and the contents of the buffer are not modified by the callee. In addition, the notaliased annotation requires the “src” and “dest” buffers to be non-overlapping.

The concise annotations for memcpy are shown in pseudocode 1710 in FIG. 17B.

3. strncpy

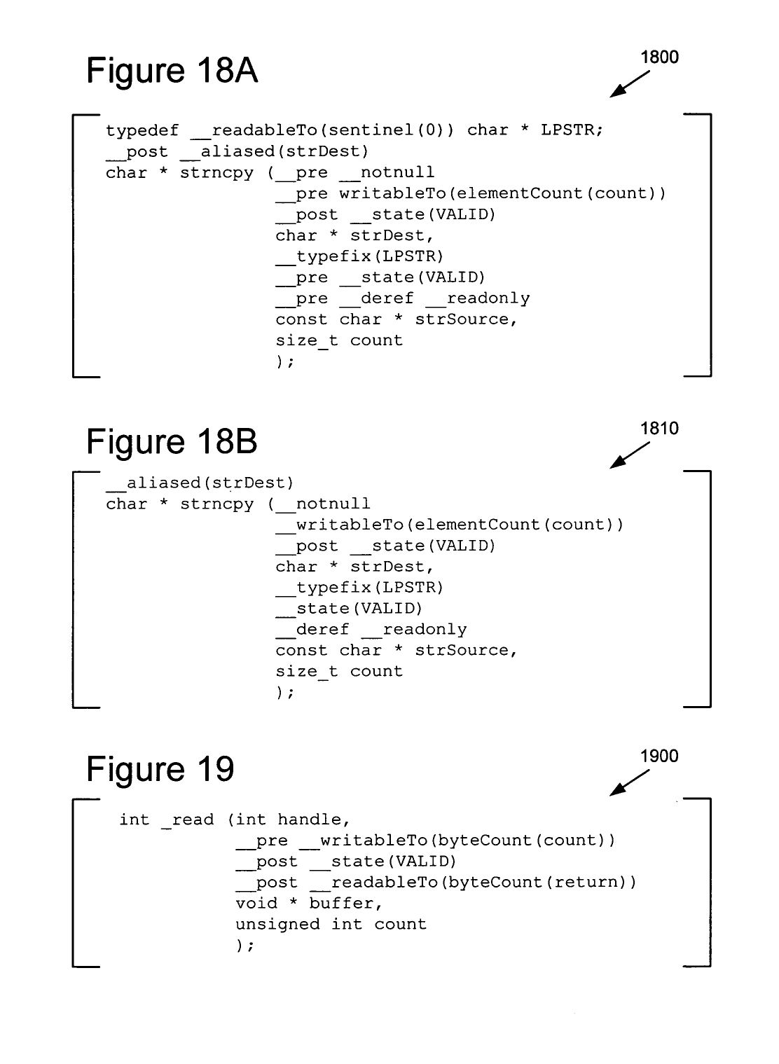

FIG. 18A shows pseudocode 1800 for an annotated version of the function strncopy. In strncpy, “strSource” is a null terminated string; this is stated by annotating the typedef on LPSTR and using typefix(LPSTR). typefix(LPSTR) is not qualified by pre or post; it applies in both states. “strDest” is a typical case of an output buffer. The preconditions state that “strDest” is notnull and writableTo(elementCount(count)).

The output buffer (or result buffer) is not annotated with typefix(LPSTR) because, while it is possible, it is not guaranteed that the buffer is null-terminated on exit. There is no postcondition for the number of readable bytes in the buffer, because that number would be given by min(elementCount(count), sentinel(0)). Although the min operation is not in the grammar of size specifications in some implementations, other versions could account for operations such as min, in addition to other operations. Some versions of the language omit support for complex operators such as min where the fact that a function like strncpy cannot be annotated with simpler size specifications suggests that the function should in fact not be used. An alternative version of strncpy null-terminates the destination buffer.

Concise annotations for strncpy are shown in pseudocode 1810 in FIG. 18B.

4. _read

FIG. 19 shows pseudocode 1900 for an annotated version of the function _read. The annotations shown in pseudocode 1900 for _read are similar to the annotations on memcpy. However, on exit, the readable byte count for the buffer is specified by the return value, as indicated using the special name return.

B. Examples: Applying Annotations to RPC Stubs in MIDL

The Microsoft® Interface Definition Language (MIDL) defines interfaces between client and server programs. A MIDL compiler can be used to create interface definition files and application configuration files for remote procedure call (RPC) interfaces. MIDL uses certain attributes (typically enclosed in brackets) to describe characteristics of functions and data structures. For example, the [in] and [out] attributes specify the direction in which parameters are passed.

The following examples show example translations of MIDL attributes into source code annotation language. Alternatively, RPC stub interfaces can be annotated in different ways.

1. RPCinit and VALID

For RPC interfaces, the RPCinit state describes a data structure that is valid to be passed to a stub in an [out] parameter position. Because of the workings of RPC client side stubs, the data structures in state RPCinit cannot contain uninitialized data. RPCinit captures what must be initialized in such data structures.

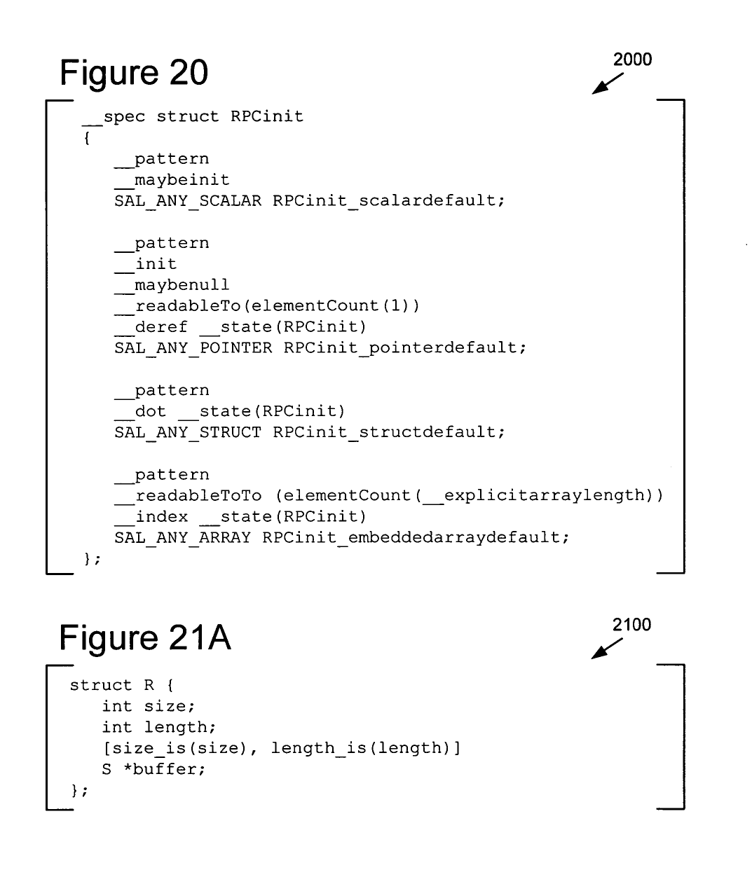

The state RPCinit must in principle be defined for each struct used in an RPC interface. However, we can factor most of the annotations into a common specification struct with patterns, as shown in pseudocode 2000 in FIG. 20. The RPCinit state captures the requirements that memory reachable by RPC stubs through [out] parameters must have a defined pointer structure—pointers must be initialized and either be null or point to valid RPCinit memory. Scalars need not be initialized.

Note the use of readableTo in the patterns for pointers and arrays. This may be unintuitive at first, since the state describes a data structure that is to be filled in by the RPC stub. However, because the RPC stub tries to reuse memory, it will read all pointers in the data structures passed in. Scalars are not read, but the specification makes that precise, since scalars are annotated as maybeinit. Thus, the combination of readableTo and maybeinit has the same meaning as writableTo in the case of scalars.

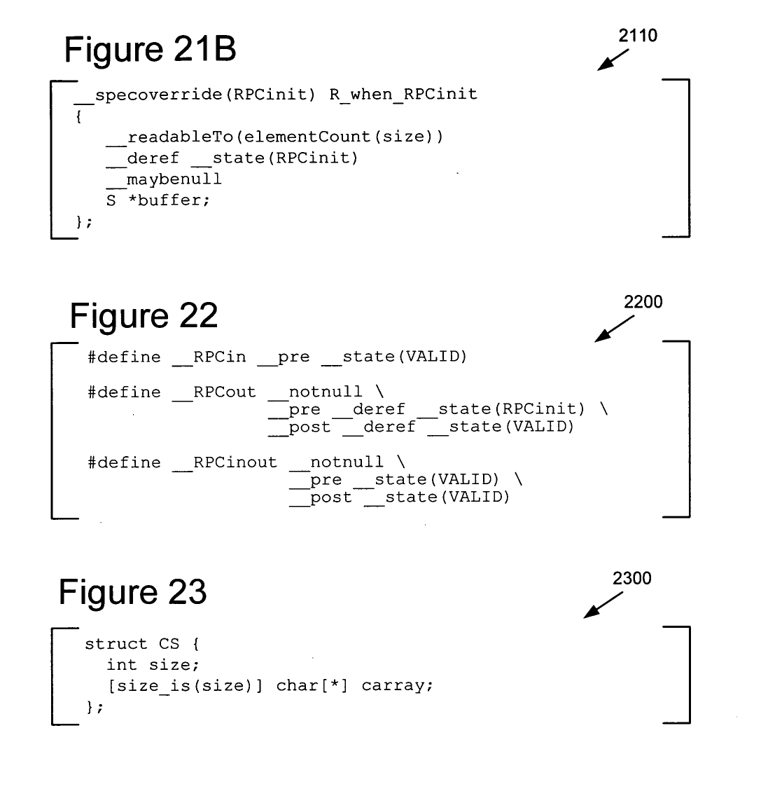

For a particular program struct used in an RPC interface, it may be necessary to extend the RPCinit specification to account for the particular properties of the program struct. For example, for the program struct R shown in pseudocode 2100 in FIG. 21A, a specification can be defined as shown in pseudocode 2110 in FIG. 21B. Note that the extension from RPCinit reduces the annotation burden to only the particular fields whose annotations are not covered by the patterns in RPCinit. Here, we need to only specify that the buffer is readable to the field size and that the element's state is itself RPCinit.

For program structs without buffers, no specification struct is needed. In general, explicit specification structs are needed for program structs containing any [ref], [size_is], or [lengthis] attributes. (The [ref], [size_is] and [lengthis] attributes are described in further detail below.) For parameters, the annotations would be as follows:

```
#define _RPCin _pre _state(VALID)
#define _RPCout _notnull \
        _pre _deref _state(RPCinit) \
        _post _state(VALID)
```

2. Translation of MIDL Structs

A MIDL struct is a data structure used in the MIDL language. Each structure member of a MIDL struct can be associated with optional field attributes that describe characteristics of that structure member for the purposes of a remote procedure call. Valid field attributes for a MIDL struct include [first_is], [last_is], [length_is], [max_is]; usage attributes [string], [ignore], and [context_handle]; pointer attributes [ref], [unique], and [ptr]; and the union attribute [switch_type].

Using annotations, a MIDL struct can be translated into two structs: (1) a struct T used by the program, which includes annotations for the VALID state of such objects; and (2) a specification struct T_when_RPCinit, which captures the properties of objects passed as [out] parameters. This second struct is only necessary if the default patterns in the RPCinit specification are inadequate.

The annotations that are added to T (and therefore implicitly to the specification struct T_when_VALID) are those that are needed in addition to the default annotations provided by the VALID specification. For RPC, this includes [ref] pointers (which cannot be null), and length or size specifications of embedded and pointed to buffers.

Table 14 shows annotations corresponding to MIDL attributes.

TABLE 14
Annotations Corresponding to MIDL Attributes for Program Struct T

| MIDL attribute | Annotation |
|---|---|
| [length_is(l)] | _readableTo(elementCount(l)) |
| [size_is(s)] | _readableTo(elementCount(s)) // provided |
| | there is no length_is |
| | _writableTo(elementCount(s)) |
| [ref] | _notnull _notaliased |
| [unique] | _notaliased (if desired) |
| [string] | _readableTo(sentinel(0)) |

In addition, for fields that have an annotation as above, the VALID specifications must be repeated (as shown in Table 15), since they are overridden:

TABLE 15
Repeated VALID Specifications for Program Struct T

| Annotated Field Type | Additional Annotation |
|---|---|
| T* | _deref _state(VALID) |
| T[*] | _index _state(VALID) |

For a program struct T whose fields have MIDL attributes of the form [ref], [size_is], or [length_is], a program struct-specific RPCinit specification is used. In this example, the specification struct is named T_when_RPCinit. However, other naming conventions can be used.

The specification struct need only contain fields that have corresponding MIDL attributes. The following tables give translations from MIDL to source code annotation language.

TABLE 16
Annotations Corresponding to MIDL Attributes for Specification Struct
T_when_RPCinit

| MIDL field attribute | Annotation |
|---|---|
| [size_is(s)] | _readableTo(elementCount(s)) |
| [length_is(l)] | _readableTo(elementCount(l)) // provided |
| | there is no size_is |
| [ref] | _notnull _notaliased |
| [unique] | no annotation needed (_notaliased is default in |
| | RPCinit spec) |
| [ptr] | _maybealiased |
| [string] | no annotation |

In addition, for fields that are annotated as above, the RPCinit defaults must be repeated, since they are overridden:

TABLE 17
Repeated RPCinit Specifications for Specification Struct
T_when_RPCinit

| Annotated Field Type | Additional Annotation |
|---|---|
| T* | _deref _state(RPCinit) |
| T[*] | _index _state(RPCinit) |

3. Translation of MIDL Prototypes

A translation of the MIDL attributes for prototypes is provided below with reference to FIG. 22.

In MIDL, the [in] and [out] attributes specify the direction in which parameters are passed. The [in] attribute indicates that a parameter is to be passed from the calling procedure to the called procedure. The [out] attribute identifies pointer parameters that are returned from the called procedure to the calling procedure (from the server to the client). A parameter can be defined as [in]-only, [out]-only, or [in, out]. An [out]-only parameter is assumed to be undefined when the remote procedure is called and memory for the object is allocated by the server. Since top-level pointer/parameters must always point to valid storage, and therefore cannot be null, [out] cannot be applied to top-level [unique] or [ptr] pointers.

The macros shown in pseudocode 2200 in FIG. 22 can be used for the translation to annotation language. Table 18 below shows translations of [in], [out], [in, out], and related MIDL attributes into annotations.

TABLE 18
Annotations Corresponding to MIDL Attributes for Prototypes

| MIDL Attribute | Annotation |
|---|---|
| [in] | _RPCin |
| [out] | _RPCout |
| [in, out] | _RPCinout |
| [length_is(1)] | _pre _readableTo(elementCount(1)) |
| | // if no [out] or no [size_is] |
| | _post _readableTo(elementCount(1)) |
| [size_is(1)] | _pre _readableTo(elementCount(1)) |
| | _post _readableTo(elementCount(1)) |
| | // if [out] parameter and no |
| | [length_is] annotation. |

4. Conformant Structs

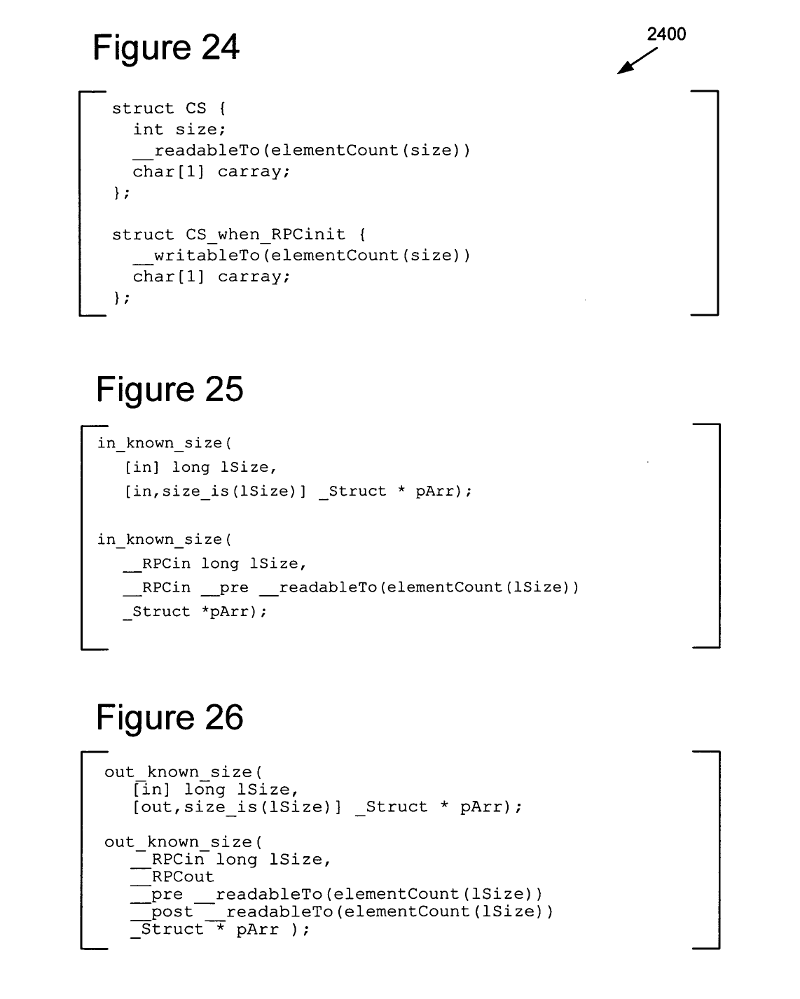

Conformant structs are program structures ending in a flexible embedded array. The size of the flexible array is specified in MIDL using [length_is] or [size_is]. A definition of a conformant struct CS is shown in pseudocode 2300 in FIG. 23. A readableTo or writableTo annotation can be added to the array member and to the specification struct CS_when_RPCinit, as shown in pseudocode 2400 in FIG. 24. In some implementations, readableTo can be replaced with deref(size).

5. Other MIDL Examples

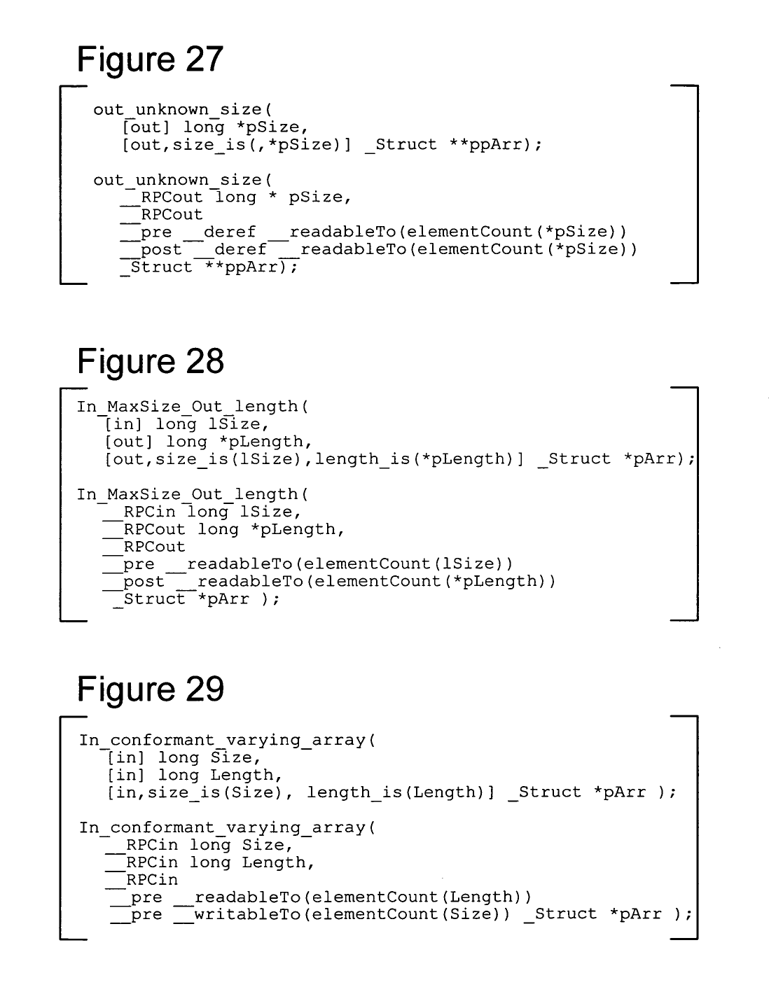

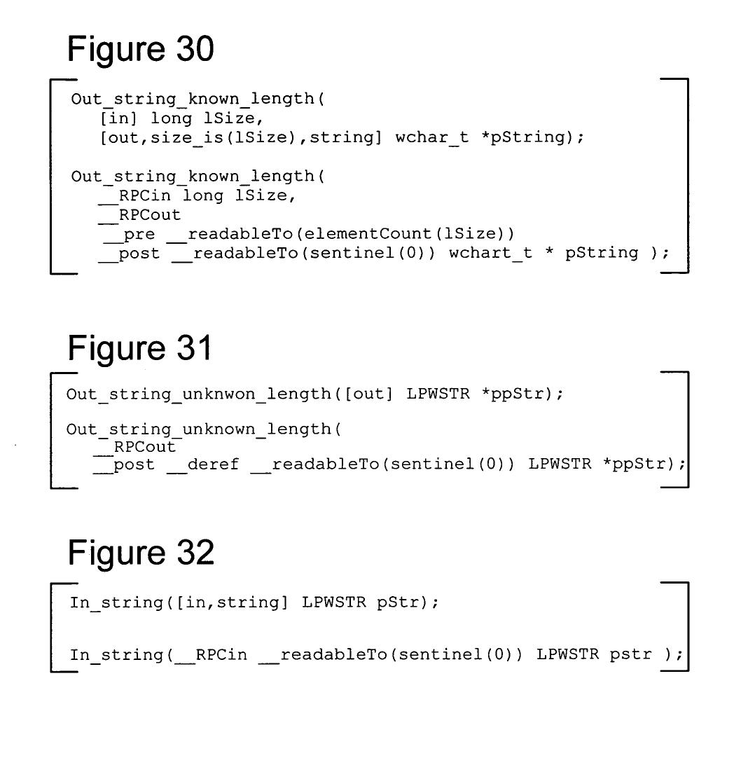

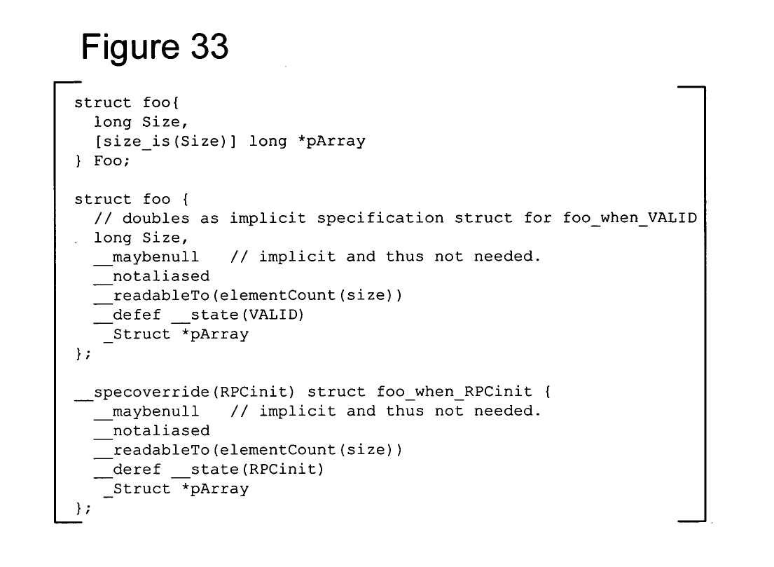

FIGS. 25-33 show additional examples of translations from MIDL to source code annotation language. FIGS. 25-32 show translations of MIDL function prototypes, and FIG. 33 shows a translation of a MIDL struct containing variable sized data.
In FIGS. 25-32, the prototypes are for the following functions:
FIG. 25: send variable length array from client to server;
FIG. 26: send variable length array from server to client (size specified by client);
FIG. 27: send variable length array from server to client (size specified by server);
FIG. 28: send variable length array from server to client (total memory size specified by client, element count sent on wire specified by server-specified *pLength);
FIG. 29: send variable length array from client to server (total memory size specified by “Size,” element count sent on wire specified by pLength);
FIG. 30: send string from server to client (string length should be smaller than lSize);
FIG. 31: send string from server to client (server determines size);
FIG. 32: send string from client to server.

6. Detailed MIDL Example

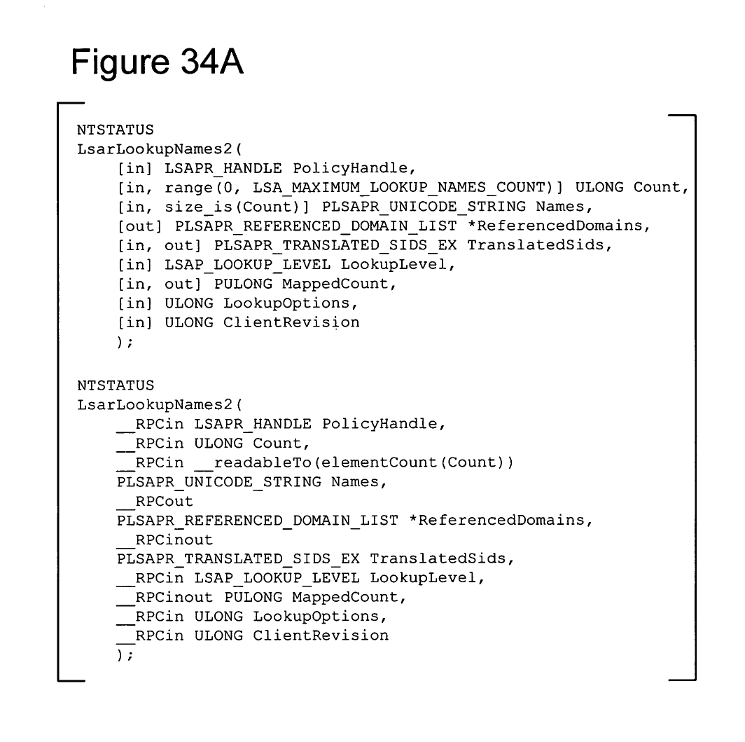

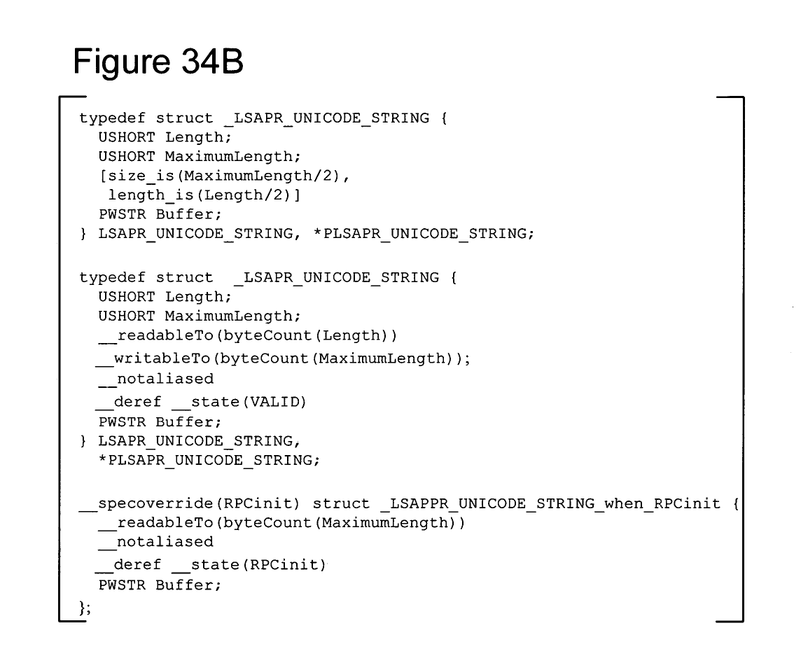

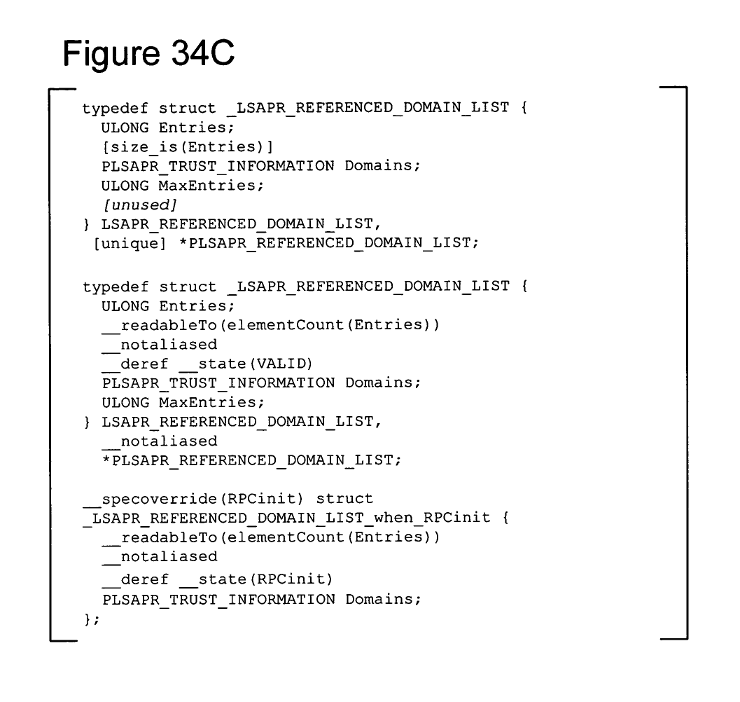

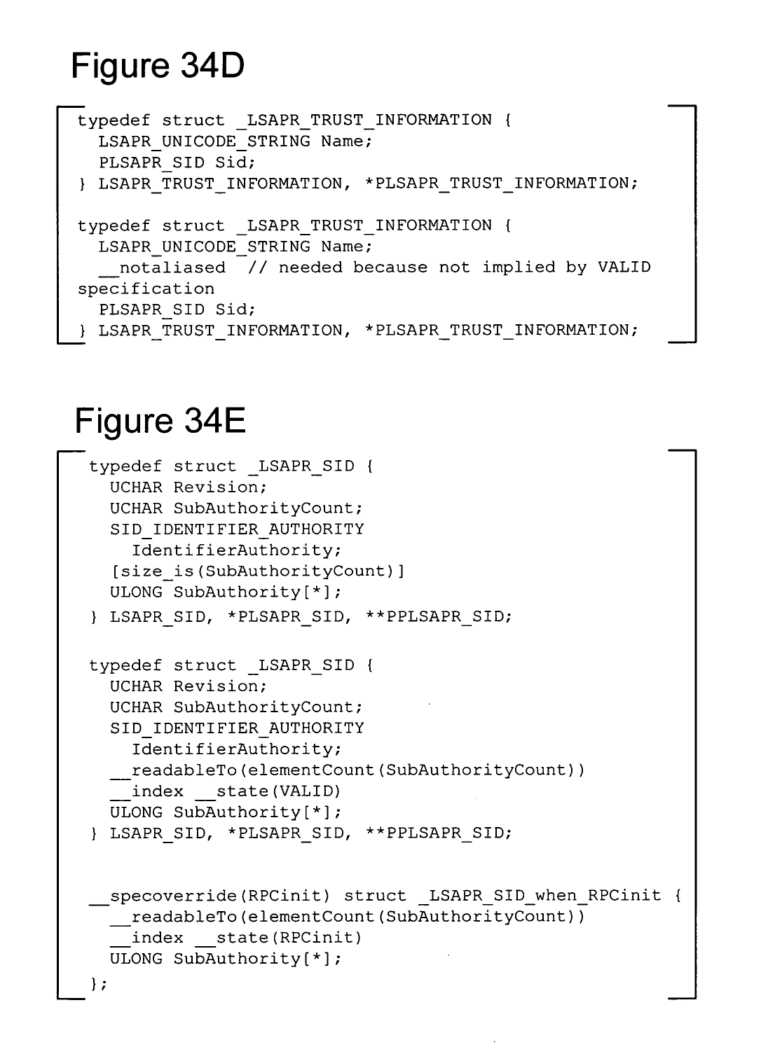

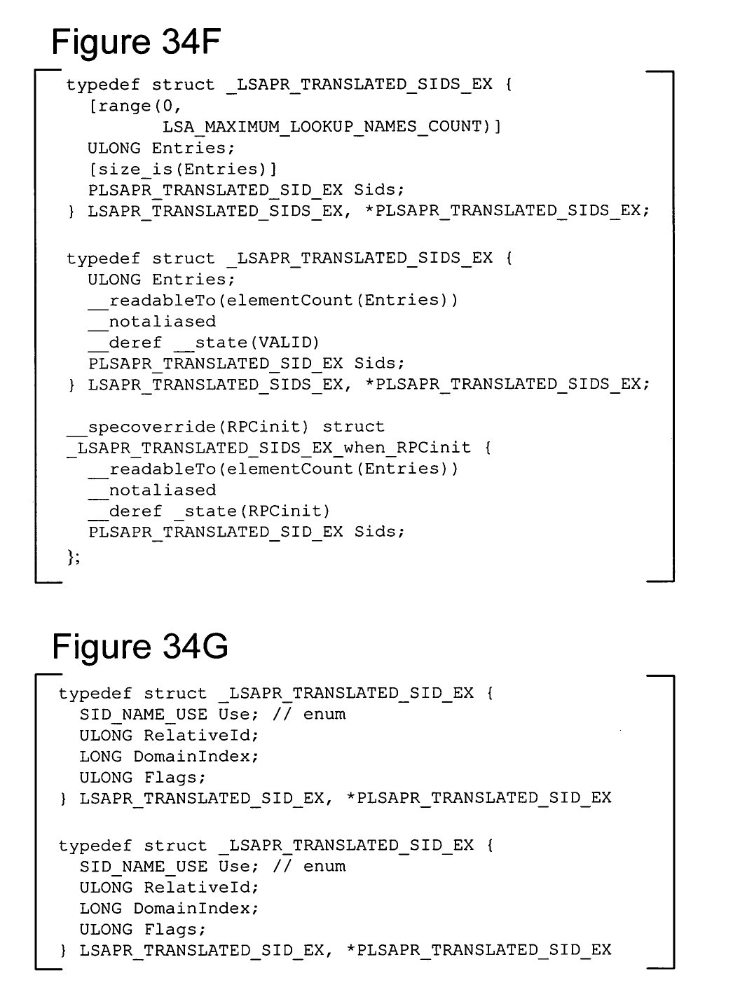

FIGS. 34A-34G show a detailed example of a translation from MIDL to source code annotation language for the RPC method LsarLookupNames2. FIG. 34A shows a translation of the prototype, and FIGS. 34B-34G show translations of the program structs used by the method.

In the struct _LSAPR_UNICODE_STRING, a nontrivial translation of Length/2 to byteCount(Length) is performed. It is also possible to use the division with an elementCount. FIGS. 34D and 34G are examples of cases where no specification struct is specified for RPCinit because the default can be used. Alternatively, an explicit specification struct can be specified.

IV. Grammar Variation

This section describes a grammar variation used in one implementation. Other variations are possible.

The grammar in this example uses the following grammar rules.

```
parameter-annot ::= basic_annot
field-annot ::= basic_annot
return-annot ::= basic_annot
function-annot ::= basic_annot
basic_annot ::= at(path) basic_annot
    | begin basic_annot ⁺ end
    | select basic_annot ⁺ end
    | pre basic_annot
    | post basic_annot
    | cond(pred) basic_annot
    | atom_annot
atom_annot ::= p
```

In this grammar, there are extra well-formedness conditions on annotations not enforced by the grammar. For each path from the root to a leaf in an annotation parse tree, there can be at most one occurrence of pre or post. For annotations appearing on something other than functions (e.g., parameters, return values, fields, etc.) the paths appearing in at qualifiers must be relative paths. For annotations on functions, each path from the root to a leaf in the annotation parse contains at most one at(path) qualifier, and the path is absolute.

A. Path Qualifiers

In this grammar variation, paths follow the syntax of C expressions for dereferencing, selecting fields, and array indices. We distinguish two kinds of paths, relative and absolute. The at(path) qualifier specifies where the qualified basic_annot applies. The path expression is used according to the following grammar.

| | |
|---|---|
| path ::= { } | // hole where the implicit parameter/return fits in. |
| | Defines a relative path. |
| \| param | // explicit parameter name (including “this”). |
| | Defines an absolute path. |
| \| return | // applies to return value. Defines an absolute path. |
| \| n | // explicit numbered parameter, starting at 0, |
| | not including “this”. Defines absolute path. |
| \| *path | // applies to dereference of path |
| \| path . f | // applies to field f at path |
| \| path -> f | // applies to dereference of field f at path |
| \| path . {*} | // applies to all fields at path |
| \| path -> {*} | // applies to the dereferencing of all fields at path |
| \| path [range] | // applies to all indices in range in the array at path |
| \| ( path ) | // parenthesis to disambiguate precedence |

The ranges and related expressions are as follows:

| | |
|---|---|
| range ::= number | // a single index given by number expression. |
| \| [ startindex , ] size | // explicit range from startindex (default 0) with |
| | size |
| startindex ::= number | // interpreted as an index according to the type |
| | of the annotated object |
| \| byteOffset(number) | // explicit byte offset. |
| size ::= * | // all elements |
| \| sizespec | // sizespec according to SAL 1.2.. |
| \| number | // shorthand for elementCount(number) |

For example, in the expression

int F(at(“*{ } ”) notnull int **p);

the notnull annotation applies to *p. That is obtained by replacing the hole { } in the path expression with parameter p. In the expression

int F(at(“*({ }->f)”) notnull struct S *p );

the notnull annotation applies to *(p->f). In the expression

int F(at(“{ } [elementCount(x)]-><any>)”) notnull struct S **p, int x);

the notnull annotation applies to all fields of *p[0] . . . *p[x−1]

The last annotation could also be written on the function itself as follows:

int F(struct S **p, int x)
at(“p[elementCount(x)]->{*})”) notnull;

Relative at qualifiers are composed in the following way:

at(path1) at(path2)=at(path2 [path1/{ }]

where path2 [path1/{ }] stands for the textual replacement of { } inpath2 by path1. The semantics in provided below make this precise for arbitrary compositions.

B. Conditional Predicates

In this grammar variation, the qualifier cond(pred) makes the following annotation conditional on predicate pred. Semantically, the meaning of cond(pred) P is the implication pred=>P.

C. Conjunctions and Disjunctions

Juxtaposition in this variation by default conjunction. For nested grouping we have two forms. The first is:

begin basic_annot ⁺ end

The meaning of begin P1 . . . Pn end is the conjunction P1 [symbol] P2 [symbol] . . . [symbol] Pn.

Disjunctions take the form

select basic_annot ⁺ end

The meaning of select P1 . . . Pn end is the disjunction P1 [symbol] P2 [symbol] . . . [symbol] Pn.

D. Atomic Predicates

Atomic predicates used in this grammar variation are described below in Table 19.

TABLE 19
Atomic Predicates

| Property | Meaning |
|---|---|
| pred( pred ) | Can only appear in an annotation tree on a function |
| | itself, or on a struct, but not on parameters or return |
| | positions. |
| | The annotation holds if the predicate pred holds. This |
| | annotation is used as an escape hatch to write properties |
| | that cannot be written using primitives. For example, one |
| | can write post pred(return > 0) to specify that the return |
| | value is positive, or pre pred(x > y) to indicate that |
| | parameter y must be strictly greater than parameter x in |
| | the precondition state. |
| error(message) | Logically, this predicate is always false. This is useful in |
| | conjunction with conditional predicates. It allows for |
| | customized error reporting. For example: |
| | int F (int x) |
| | cond(x<0) error(“Don't pass negative numbers to F”) |
| | ; |

E. Semantics

We give semantics to annotations in this grammar variation by normalizing them first to the following restricted grammar form:

| | |
|---|---|
| norm_annot ::= begin norm_annot ⁺ end | // conjunction |
| \| select norm_annot ⁺ end | // disjunction |
| \| norm_atom_annot | |
| norm_atom_annot ::= ( pre \| post ) cond(pred) | |
| at(path) p | |

A normalized annotation consists of an AND-OR tree where each leaf is a normalized atomic annotation consisting of a pre or post, a single condition, a single absolute at path, and a single primitive propertyp.

Normalization pushes conditions, paths, and pre/post to the leaves and resolves relative paths by replacing them with absolute ones. The normalization is always possible, due to the restrictions that only relative paths can occur multiple times, and that on each path from the root to a leaf of the parse tree, there is at most a single pre/post annotation.

The following definition of Normalize(ba, state, cond, subject) transforms a basic annotation ba, into a normalized annotation, using the default state (pre or post), under condition cond, and default subject (if the annotation appears on a parameter) to fill path holes.
Normalize(at(path) ba, state, cond, subject)=Normalize (ba, state, substitute (subject)/{ } in path)
Normalize(begin bal . . . ban end, state, cond, subject)=begin Normalize (bal, state, cond, subject) . . . Normalize (ban, state, cond, subject) end
Normalize(select bal . . . ban end, state, cond, subject)=select Normalize (bal, state, cond, subject) . . . Normalize (ban, state, cond, subject) end
Normalize(pre ba, state, cond, subject)=Normalize (ba, pre, cond, subject)
Normalize(post ba, state, cond, subject)=Normalize (ba, post, cond, subject)
Normalize(cond(pred) ba, state, cond, subject)=Normalize (ba, state, cond && pred, subject)
Normalize(p, state, cond, subject)=state cond(cond) at(subject) p

A basic annotation ba on a parameters is normalized to Normalize(ba, pre, true, p). A basic annotation ba on the return value is normalized to Normalize(ba, post, true, return). A basic annotation ba on a function is normalized to Normalize(ba, pre, true, { }).

The meaning of a normalized annotation is then computed relative to a given pre and post state by evaluating all the leaves (normalized atomic annotations) using the pre and post states to look up values at the given paths in memory (return is treated as a special variable in the post state). The overall value of the annotation is then computed by computing the AND-OR tree bottom up.

### V. Computing Environment

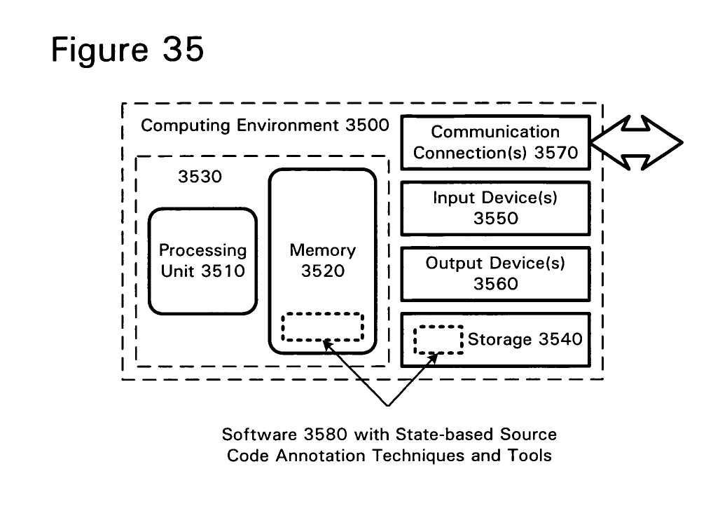

The techniques and tools described above can be implemented on any of a variety of computing devices and environments, including computers of various form factors (personal, workstation, server, handheld, laptop, tablet, or other mobile), distributed computing networks, and Web services, as a few general examples. The techniques and tools can be implemented in hardware circuitry, as well as in software 3580 executing within a computer or other computing environment, such as shown in FIG. 35.

FIG. 35 illustrates a generalized example of a suitable computing environment 3500 in which the described techniques and tools can be implemented. The computing environment 3500 is not intended to suggest any limitation as to scope of use or functionality of the invention, as the present invention may be implemented in diverse general-purpose or special-purpose computing environments.

With reference to FIG. 35, the computing environment 3500 includes at least one processing unit 3510 and memory 3520. In FIG. 35, this most basic configuration 3530 is included within a dashed line. The processing unit 3510 executes computer-executable instructions and may be a real or a virtual processor. In a multi-processing system, multiple processing units execute computer-executable instructions to increase processing power. The memory 3520 may be volatile memory (e.g., registers, cache, RAM), non-volatile memory (e.g., ROM, EEPROM, flash memory, etc.), or some combination of the two. The memory 3520 stores software 3580 implementing state-based source code annotation techniques and tools, and/or other annotation techniques and tools.

A computing environment may have additional features. For example, the computing environment 3500 includes storage 3540, one or more input devices 3550, one or more output devices 3560, and one or more communication connections 3570. An interconnection mechanism (not shown) such as a bus, controller, or network interconnects the components of the computing environment 3500. Typically, operating system software (not shown) provides an operating environment for other software executing in the computing environment 3500, and coordinates activities of the components of the computing environment 3500.

The storage 3540 may be removable or non-removable, and includes magnetic disks, magnetic tapes or cassettes, CD-ROMs, CD-RWs, DVDs, or any other medium which can be used to store information and which can be accessed within the computing environment 3500. For example, the storage 3540 stores instructions for implementing software 3580.

The input device(s) 3550 may be a touch input device such as a keyboard, mouse, pen, or trackball, a voice input device, a scanning device, or another device that provides input to the computing environment 3500. For audio, the input device(s) 3550 may be a sound card or similar device that accepts audio input in analog or digital form, or a CD-ROM reader that provides audio samples to the computing environment. The output device(s) 3560 may be a display, printer, speaker, CD-writer, or another device that provides output from the computing environment 3500.

The communication connection(s) 3570 enable communication over a communication medium to another computing entity. The communication medium conveys information such as computer-executable instructions, audio/video or other media information, or other data in a modulated data signal. By way of example, and not limitation, communication media include wired or wireless techniques implemented with an electrical, optical, RF, infrared, acoustic, or other carrier.

The techniques and tools described herein can be described in the general context of computer-readable media. Computer-readable media are any available media that can be accessed within a computing environment. By way of example, and not limitation, with the computing environment 3500, computer-readable media include memory 3520, storage 3540, communication media, and combinations of any of the above.

Some of the techniques and tools herein can be described in the general context of computer-executable instructions, such as those included in program modules, being executed in a computing environment on a target real or virtual processor. Generally, program modules include functions, programs, libraries, objects, classes, components, data structures, etc. that perform particular tasks or implement particular abstract data types. The functionality of the program modules may be combined or split between program modules as desired. Computer-executable instructions may be executed within a local or distributed computing environment.

In view of the many possible embodiments to which the principles of our invention may be applied, we claim as our invention all such embodiments as may come within the scope and spirit of the following claims and equivalents thereto.

We claim:

1. In a computer system, a method of annotating computer program code stored on a computer-readable medium, the computer program code operable to cause a computer to perform according to instructions in the computer program code, the method comprising:
annotating a target data structure in the computer program code with a state-defining code annotation, wherein the state-defining code annotation assigns a named state to the target data structure, and wherein the named state is operable to describe one or more characteristics of one or more elements of the target data structure.

2. The method of claim 1 wherein the state-defining code annotation overrides an implicit state definition for the target data structure.

3. The method of claim 1 wherein at least one property on at least one field of the data structure is determined by the named state for the target data structure.

4. The method of claim 3 wherein:
the at least one field is a valid pointer; and
the at least one property is maybenull.

5. The method of claim 1 wherein the state-defining code annotation is an annotation that takes an argument, and wherein the argument defines the named state.

6. The method of claim 5 wherein the state-defining code annotation is state(S).

7. The method of claim 5 wherein the argument is a specification struct.

8. The method of claim 1 wherein the state-defining code annotation is at least part of a postcondition for the target data structure.

9. The method of claim 8 wherein the postcondition is a conditional postcondition.

10. The method of claim 1 wherein the state-defining code annotation is at least part of a precondition for the target data structure.

11. The method of claim 1 wherein the target data structure is a struct comprising plural fields.

12. The method of claim 1 wherein the named state applies to plural fields of the target data structure.

13. A method of annotating computer program code stored on a computer-readable medium, the method comprising:
annotating an annotation target with a code annotation, wherein the code annotation is a specification data structure having one or more fields, and wherein the one or more fields of the specification data structure define a state for the annotation target.

14. The method of claim 13 wherein the state is “valid.”

15. The method of claim 13 wherein the state is a remote procedure call state.

16. The method of claim 13 wherein a field of the specification data structure comprises a type pattern.

17. The method of claim 16 wherein the type pattern comprises at least one annotation and a specified data type to which the type pattern applies, wherein the annotation target matches the specified data type to which the type pattern applies, and wherein at the least one annotation in the type pattern is applied to the annotation target.

18. The method of claim 13 further comprising annotating the annotation target with a recursive propagation annotation, the recursive propagation annotation operable to propagate the state though a pointer dereference of the annotation target.

19. The method of claim 13 wherein the specification data structure comprises a projection of another specification data structure.

20. A computer programmed as a program code annotation system, the computer comprising:
a memory storing code for the program code annotation system; and
a processor for executing the code for the program code annotation system;
wherein the code for the source code annotation system comprises:
code for instructing a computer to add one or more annotations to one or more annotation targets in program code, wherein the one or more annotations each comprise an arrangement of one or more annotation elements, and wherein at least one of the annotations comprises a specification struct for describing a state of at least one annotation target in the program code.
